(19) United States
(12) Patent Application Publication
(10) Pub. No.: US 2024/0281588 A1
(43) Pub. Date: Aug. 22, 2024

(54) A METHOD FOR COMPUTING PHYSICAL QUANTITIES OF A CONDUCTIVE BODY, CORRESPONDING PROCESSING SYSTEM AND COMPUTER PROGRAM PRODUCT

(71) Applicant: UNIVERSITÀ DEGLI STUDI DI UDINE, Udine (IT)

(72) Inventors: Ruben SPECOGNA, Udine (IT); Silvano PITASSI, Udine (IT); Mauro PASSAROTTO, Udine (IT)

(21) Appl. No.: 18/569,569

(22) PCT Filed: Jun. 8, 2022
(86) PCT No.: PCT/IB2022/055315

§ 371 Date: Dec. 12, 2023

(30) Foreign Application Priority Data
Jun. 15, 2021 (IT) 102021000015602

(51) Int. Cl. G06F 30/392; G06F 17/12; G06F 111/10; G06F 119/06

(52) U.S. Cl. CPC G06F 30/392; G06F 17/12; G06F 2111/10; G06F 2119/06

(57) ABSTRACT

Techniques of computing values of physical parameters of a conductive body immersed in an electromagnetic field produced by at least one source of electromagnetic energy are provided.

### TECHNICAL FIELD

The description relates to methods for analysis and computation of electromagnetic parameters of an object using space discretization, by the construction of a 2D or 3D mesh of the object, for instance.

One or more embodiments may be applied to numerical simulation of eddy currents in electronic devices and circuits.

### TECHNOLOGICAL BACKGROUND

Electrical wiring in electronic circuits such as those present in printed-circuit-boards (PCBs), for instance, can suffer from parasitic effects known as eddy currents.

Eddy currents are loops of electrical current induced in conductors by a varying electromagnetic field, according to Faraday's law. For instance, a source current density varying in time-and-space can be induced within nearby stationary conductors by a time-varying magnetic field created by an AC electromagnet or transformer.

An eddy current induced in a conductor:
induces a magnetic field which, according to Lenz's law, counters the time-varying magnetic field from which the eddy current originates,
dissipates energy as heat in the material, causing energy loss in alternating current (AC) inductors, transformers, electric motors and other circuits.

For these reasons, taking into account eddy currents can be relevant in designing (and manufacturing) electronic devices and embedded electronic devices in integrated circuits.

Existing methods of analysis of eddy current phenomena in electronic devices mainly belong to:
finite elements methods (FEM), based on numerically solving differential equations locally after segmenting a large system into smaller, simpler parts called “finite elements”; a global solution is built using variational methods by minimizing an error function;
partial element equivalent circuit (PEEC) methods, based on loop currents of network theory or Volume Integral (VI) formulations based on the electric vector potential, use Biot-Savart law to produce non-local constitutive laws that lead to fully populated generalized mass matrices called inductance matrices.

All aforementioned methods involve space discretization by the construction of a mesh of the object corresponding to a finite computational domain.

PEEC and VI methods can be computationally advantageous in that a full analysis can be obtained even modeling only conductive elements of an electronic device, without modeling insulating elements of the circuit.

These methods are subject of extensive literature, as witnessed, e.g., by documents:

A. E. Ruehli, “Equivalent Circuit Models for Three-Dimensional Multiconductor Systems,” in IEEE Transactions on Microwave Theory and Techniques, vol. 22, no. 3, pp. 216-221, March 1974, doi: 10.1109/TMTT.1974.1128204 which discusses equivalent circuit models are derived here from an integral equation to establish an electrical description of the physical geometry, the models called partial element equivalent circuits (PEEC) in that they include losses, where models of different complexity can be constructed, to suit the application at hand.

Albanese, R.; Rubinacci, G.: ‘Integral formulation for 3D eddy-current computation using edge elements’, IEE Proceedings A (Physical Science, Measurement and Instrumentation, Management and Education, Reviews), 1988, 135, (7), p. 457-462, DOI: 10.1049/ip-a-1.1988.0072 which discusses an integral formulation for eddy-current problems in nonmagnetic structures, where the solenoidality of the current density is assured by introducing an electric vector potential T whose curl represents the current,

G. Rubinacci and A. Tamburrino, “A Broadband Volume Integral Formulation Based on Edge-Elements for Full-Wave Analysis of Lossy Interconnects,” in IEEE Transactions on Antennas and Propagation, vol. 54, no. 10, pp. 2977-2989, October 2006, doi: 10.1109/TAP.2006.882156 which discusses a numerical fully three-dimensional (3D) volume integral formulation for the electromagnetic analysis from static to microwave frequencies of penetrable materials (dielectric, eventually lossy, and conductors with finite conductivity), where a volumetric loop-star decomposition for treating piecewise homogeneous materials is introduced.

Existing PEEC methods may suffer from one or more of the following drawbacks:
rely on integral calculus, which may involve heavy calculations,
computation of a double volume integral involves strongly singular multiple integrals;
as integration is numerically performed with, for example, Gaussian, rules (e.g., quadrature) of different order, this introduces errors/approximations which lead to inaccuracy of the analysis,
computational complexity and memory consumption grow (asymptotically) with the square of the number of elements of matrices used to perform calculations; in other words, if the problem becomes ten times bigger, the memory and the computation time increase by at least a hundred;
risk of rapid memory saturation, in particular when implemented on relatively simple processing systems.

In particular, memory consumption is a bottleneck that limits the size of the problem that can be analyzed with existing methods, whereas time consumption is a bottleneck for the practical use thereof.

Various approaches are discussed, for example, in documents:
M. Kamon, M. J. Tsuk and J. K. White, “FASTHENRY: a multipole-accelerated 3-D inductance extraction program,” in IEEE Transactions on Microwave Theory and Techniques, vol. 42, no. 9, pp. 1750-1758, September 1994, doi: 10.1109/22.310584, which discusses a mesh analysis equation formulation technique combined with a multipole-accelerated Generalized Minimal Residual (GMRES) matrix solution algorithm that is used to compute the 3-D frequency dependent inductances and resistances in nearly order n time and memory where n is the number of volume-filaments;
A. C. Yucel, I. P. Georgakis, A. G. Polimeridis, H. Bağci and J. K. White, “VoxHenry: FFT-Accelerated Inductance Extraction for Voxelized Geometries,” in IEEE Transactions on Microwave Theory and Techniques, vol. 66, no. 4, pp. 1723-1735, April 2018, doi: 10.1109/TMTT.2017.2785842, presents a fast Fourier transform (FFT)-accelerated integral-equation-based simulator for extracting frequency-dependent inductances and resistances of structures discretized by voxels;
S. Kurz, O. Rain and S. Rjasanow, “The adaptive cross-approximation technique for the 3D boundary-element method,” in IEEE Transactions on Magnetics, vol. 38, no. 2, pp. 421-424, March 2002, doi: 10.1109/20.996112, discusses an algebraic approach where the matrices are split into collections of blocks of various sizes which describe remote interactions and are adaptively approximated by low rank submatrices, reducing algorithmic complexity for matrix setup and matrix-by-vector products to approximately O(N);
K. Zhao, M. N. Vouvakis and Jin-Fa Lee, “The adaptive cross approximation algorithm for accelerated method of moments computations of EMC problems,” in IEEE Transactions on Electromagnetic Compatibility, vol. 47, no. 4, pp. 763-773, November 2005, doi: 10.1109/TEMC.2005.857898 discusses the adaptive cross approximation (ACA) algorithm to reduce memory and CPU time overhead in the method of moments (MoM) solution of surface integral equations, comprising a multilevel partitioning of the computational domain, where interactions of well-separated partitioning clusters are accounted through a rank-revealing LU decomposition and where the acceleration and memory savings come from the partial assembly of the rank-deficient interaction submatrices;
R. Torchio, P. Bettini and P. Alotto, “PEEC-Based Analysis of Complex Fusion Magnets During Fast Voltage Transients With H-Matrix Compression,” in IEEE Transactions on Magnetics, vol. 53, no. 6, pp. 1-4, June 2017, Art no. 7200904, doi: 10.1109/TMAG.2017.2651638 discusses how adaptive cross approximation coupled with hierarchical matrix arithmetic can provide an effective method to allow the solution of large-scale problems typical of real devices;
J. Smajic, Z. Andjelic and M. Bebendorf, “Fast BEM for Eddy-Current Problems Using H-Matrices and Adaptive Cross Approximation,” in IEEE Transactions on Magnetics, vol. 43, no. 4, pp. 1269-1272, April 2007, doi: 10.1109/TMAG.2006.890971 discusses numerical experiments in applying a new technique for matrix compression and preconditioning to boundary element method (BEM)-based eddy-current analysis based on hierarchical matrix arithmetic and adaptive cross approximation techniques;
G. Rubinacci, A. Tamburrino, S. Ventre, F. Villone, A fast 3-d multipole method for eddy-current computation, IEEE Transactions on Magnetics 40 (2) (2004) 1290-1293. doi:10.1109/TMAG.2004.824585 which discusses a fast method based on the fast multipole acceleration of the computation of matrix-by-vector products arising from the discretization of an integral formulation of the three-dimensional eddy current problem;
Dimitri Voltolina, Riccardo Torchio, Paolo Bettini, Ruben Specogna, Piergiorgio Alotto, “Optimized cycle basis in volume integral formulations for large scale eddy-current problems,” Computer Physics Communications, Volume 265, 108004, 2021, ISSN 0010-4655, doi: 10.1016/j.cpc.2021.108004 which discusses Volume Integral formulations for the solution of large-scale eddy-current problems coupled with low-rank approximation techniques.

Existing approaches present one or more of the following drawbacks:
FFT-based methods are limited to specific mesh element types, e.g., Cartesian; other methods also are limited to the use of certain mesh element types;
a reduced compatibility with possible mesh element types is hardly compatible with treating various kinds of objects (for instance, with curved geometries or shapes that are not aligned), as approximations of their geometry can lead to unacceptable discretization errors (so-called “staircase error”);
when applying fast multi-pole method (FMM) to a 3D simplicial mesh, for instance, the method has to be carefully readapted for each Cartesian component separately, leading to a complex and computationally burdensome (e.g., in terms of computation time) reformulation of the numerical method;
use of algebraic compression techniques such as low-rank approximation, for which a reduction of memory footprint does not involve a reduction of the calculation time and whose extension to geometries other than simply connected ones involves burdensome and complex adjustments which increase computational resources usage,
reduced accuracy of calculations, and
limited speedup of calculations.

### OBJECT AND SUMMARY

Despite the extensive activity discussed in the foregoing, improved solutions dispensing with various drawbacks are thus desirable.

An object of one or more embodiments is to contribute in providing such an improved solution.

According to one or more embodiments, that object can be achieved by means of a method having the features set forth in the claims that follow.

A computerized or computer-implemented method that can be executed on a relatively simple processing system may be exemplary of such a method.

One or more embodiments relate to a corresponding processing system.

One or more embodiments may comprise a computer program product loadable into the memory of at least one processing circuit (e.g., a computer) and comprising software code portions for executing the steps of the method when the product is run on at least one processing circuit. As used herein, reference to such a computer program product is understood as being equivalent to reference to computer-readable medium containing instructions for controlling the processing system in order to co-ordinate implementation of the method according to one or more embodiments. Reference to “at least one computer” is intended to highlight the possibility for one or more embodiments to be implemented in modular and/or distributed form.

One or more embodiments may comprise a PCB circuit having physical quantities (e.g., electromagnetic parameters such as electrical current density values, for instance) determined using the method as per the present disclosure.

The claims are an integral part of the technical teaching provided herein with reference to the embodiments.

One or more embodiments facilitate efficiently carrying out numerical computation making use of a mesh structure comprising any kind of mesh element types.

One or more embodiments may relate to computer-aided design (and manufacturing) of conductive objects or bodies, for instance via the determination of electrical current densities flowing into these conductive bodies.

For instance, maximum value of eddy currents induced in a PCB circuit board without interfering with functioning of components mounted thereon can be exemplary of such electromagnetic parameters.

One or more embodiments may facilitate offering one or more of the following advantages:
provide a set of volume-uniform basis functions particularly adapted for the application of the Galerkin method in numerical simulations, providing efficient hardware implementations thereof,
increased analysis accuracy of numerical computations,
selecting basis functions which have the property of being volume-uniform within elements of the mesh, such as tetrahedral, hexahedral and polyhedral mesh elements;
possibility to exploit a singularity extraction (SA) technique directly in the case of uniform basis functions;
increasing computational efficiency by providing an analytical, exact solution of the computation of the double integral which can be used to evaluate the error produced in the existing techniques;
increased computational speed, for instance thanks to the possibility of pre-computing parts of the matrices involved,
lossless compressions of the integral matrix, facilitating to reduce the memory footprint without affecting accuracy,
facilitating providing analysis on larger and more complex problems with a same processing system, reducing costs and hardware complexity,
flexibility in analyzing a variety of electromagnetic interactions.

### BRIEF DESCRIPTION OF THE SEVERAL VIEWS OF THE DRAWINGS

One or more embodiments will now be described, by way of non-limiting example only, with reference to the annexed Figures, wherein:

FIG. 1 is a diagram of a processing system as per the present disclosure,

FIG. 2 is a flowchart exemplary of embodiments of a method of analysis of an electronic device,

FIG. 3 is a diagram exemplary of principles underlying embodiments,

FIG. 4 is a flowchart exemplary of operations of the processing system of FIG. 1,

FIG. 5 is a diagram exemplary of a mesh element type as per the present disclosure,

FIG. 6 is a diagram exemplary of inter-element connections of connection lines of mesh elements,

FIG. 7 is a diagram exemplary of a dual partition of a mesh element,

FIG. 8A is a diagram exemplary of an alternative mesh element type in one or more embodiments as per the present disclosure,

FIG. 8B is a diagram exemplary of basis functions in a mesh element as per the present disclosure,

FIGS. 9, 10, 11A, 11B and 12 are exemplary diagrams of benchmark of performances of a method as per the present disclosure,

FIG. 13 is a diagram of an exemplary PCB device as per the present disclosure,

FIG. 14 is a diagram exemplary of a mesh structure of a portion of the diagram of FIG. 13.

### DETAILED DESCRIPTION OF EXEMPLARY EMBODIMENTS

In the ensuing description, one or more specific details are illustrated, aimed at providing an in-depth understanding of examples of embodiments of this description. The embodiments may be obtained without one or more of the specific details, or with other methods, components, materials, etc. In other cases, known structures, materials, or operations are not illustrated or described in detail so that certain aspects of embodiments will not be obscured.

Reference to “an embodiment” or “one embodiment” in the framework of the present description is intended to indicate that a particular configuration, structure, or characteristic described in relation to the embodiment is comprised in at least one embodiment. Hence, phrases such as “in an embodiment” or “in one embodiment” that may be present in one or more points of the present description do not necessarily refer to one and the same embodiment.

Moreover, particular conformations, structures, or characteristics may be combined in any adequate way in one or more embodiments.

The drawings are in simplified form and are not to precise scale.

Throughout the figures annexed herein, like parts or elements are indicated with like references/numerals and a corresponding description will not be repeated for brevity.

The references used herein are provided merely for convenience and hence do not define the extent of protection or the scope of the embodiments.

A method of analysis of an electronic device (model) can be implemented via a relatively simple data processing system, e.g., a computer.

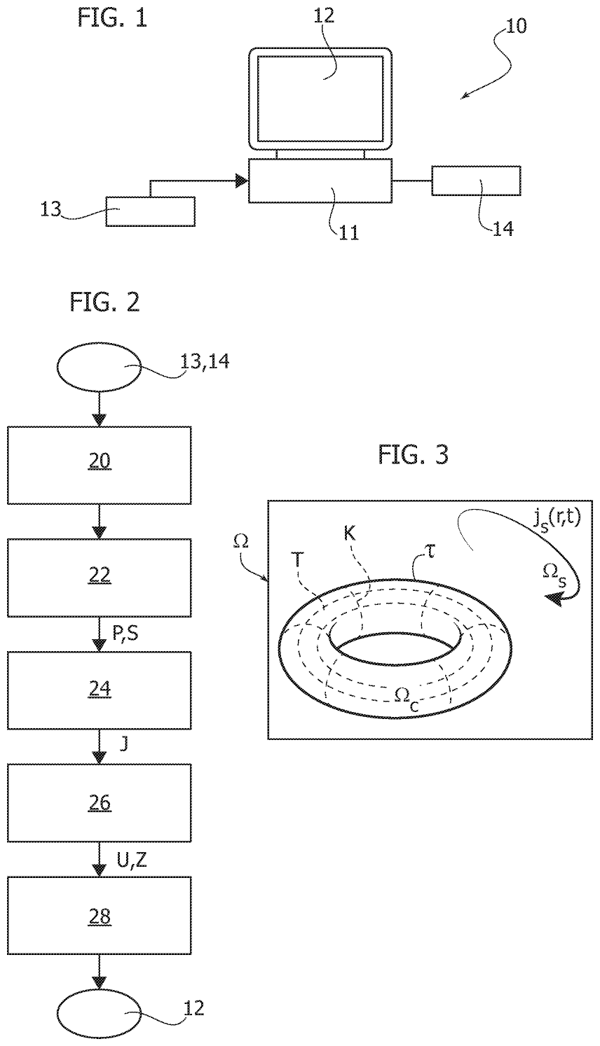

As exemplified in FIG. 1, the data processing system 10 comprises:
a processing device 11, e.g., a central processing unit (CPU) configured to perform numerical computations, for instance to solve a linear system stemming from discretizing an electric field integral equation (EFIE), as discussed in the following;
an interface 12, e.g., an image processing apparatus such as a display, configured to provide visual representation of input/output data to a user,
an input device 13 configured to provide the input data to be processed with the method as per the present disclosure, and
a data storage device 14 (such as a hard disk, for instance) accessible locally or using a distributed “cloud” storage architecture for storing or retrieving data. For instance, the data storage device 14 may also be referred to as a memory (circuit) 14.

For instance, the input device comprises at least one of a direct input device (e.g., a keyboard), a computer readable media (e.g., a USB pen) and an imaging apparatus (e.g., a scanner apparatus or electrical probes) configured to obtain a model or layout of an object, in a manner known per se to those of skill in the art.

In the considered example, the input apparatus 13 is configured to provide data on which to apply the operations of the method according to embodiments. For instance, the data comprises an electronic model or image layout (e.g., CAD or Gerber or detected via the imaging device) of a conductive object or body. This can comprise, for instance, a printed-circuit board (PCB) having at least one printed circuit layout thereon (e.g., a printed circuit layout configured to couple semiconductor devices mounted thereon).

FIG. 2 is a flowchart of a method of analysis of one or more (models of) electronic devices as per the present disclosure.

As exemplified in FIG. 2, the method comprises:
block 20: receiving, e.g., via the input device 13 or via data retrieval in the data storage device 14, a (electromagnetic) data of the electronic device P under analysis, such as a 3D CAD file or PCB 2.5D image;
block 22: receiving or providing data (e.g., a model) of an electromagnetic source S, for instance receiving technical specifications of a mesh geometry of an induction coil or providing setting values of current/voltage parameters,
block 24: performing data processing of the input data P, S, obtaining as a result one or more estimates of physical quantities of the conductive body P immersed in the at least one of an electromagnetic field distribution E emitted by the source S, such as a current density distribution J (with respective power loss), for instance,
block 26: applying post-processing to the estimated parameters E, J, P, obtaining electromagnetic parameters of the analyzed electronic device, such as frequency response U and impedance parameters Z, for instance,
block 28: providing the (electromagnetic) parameters obtained (e.g., U, Z) to a user circuit, for instance a graphical processing circuit configured to display a graphic visualization of results of processing carried out by block 26 on the display apparatus 12, e.g., during a computer-aided design (and manufacturing) process of a PCB circuit.

Optionally, block 28 may further comprise performing a comparison of the electromagnetic parameters obtained (e.g., U, Z and/or E, J) with measured physical quantities of the device P under analysis, the measured physical quantities obtained via experimental results on the device itself, in order to assess validity and accuracy of the numerical simulation method.

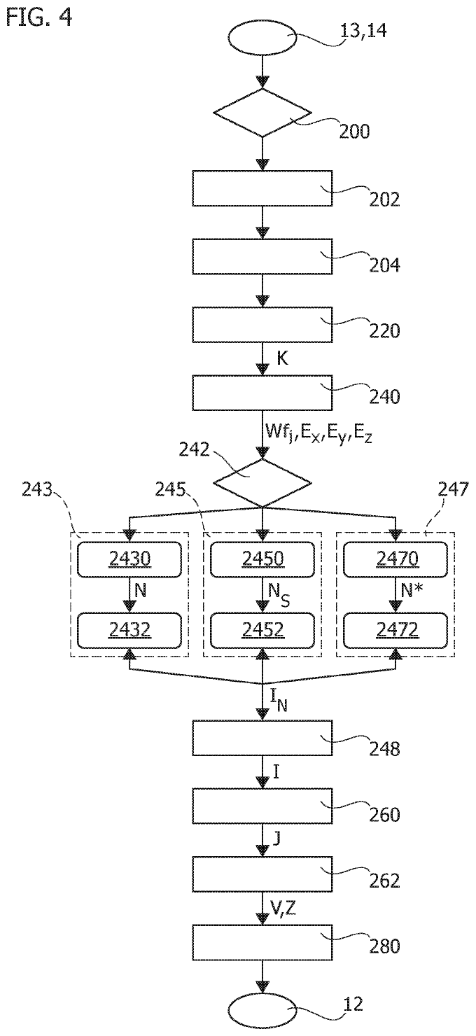

FIG. 4 is a further diagram exemplary of the method of analysis of one or more (models of) electronic devices as per the present disclosure.

For the sake of simplicity, one or more embodiments are discussed mainly with respect to a three-dimensional (3D) geometry, being otherwise understood that this is in no way limiting as the method is suitable for notionally any dimension (e.g., a 2D mesh of polygonal, preferably quadrangular, mesh elements).

For the sake of simplicity, an exemplary electromagnetic problem of interest to analyze is represented in FIG. 3 which is discussed in the following with respect to an exemplary case applicable (at least notionally) in as many contexts as possible, without loss of generality.

As exemplified in FIG. 3, an electrically conductive device Ω_{C} of any shape can be modeled as a compact manifold in a 3D (e.g., Cartesian, Euclidian) space subjected to the influence of a time-varying electromagnetic source domain Ω_{S} comprising an electrical current density field j_{S}(r,t) which may vary in time and space. In the considered example, the ensemble of the conducting body Ω_{C} and the source domain Ω_{S} forms the computational domain, Ω.

As exemplified in FIG. 3:
the source domain Ω_{S} produces a varying magnetic field that induces an eddy current flow j(r, t) in the conducting domain Ω_{C}, and
the conductive domain Ω_{C} has physical quantities or parameters associated thereto, such as resistivity σ⁻¹(r) (reciprocal of the conductivity σ(r)),
the computational domain Ω is assumed to further model the presence of an insulating media (e.g., air) having magnetic permeability μ (e.g., constant in time, uniform in space and equal to the vacuum permeability μ₀).

It is noted that one or more embodiments are discussed in the following with respect to an exemplary case where the insulating media is uniform in the computational domain Ω, being otherwise understood that this is a purely exemplary and in no way limiting case. In one or more embodiments, the computational domain Ω can include one or more insulating media having different values of magnetic permeability μ as a function of space.

For the sake of brevity, time-and/or-space variation (r,t) of physical (e.g., electromagnetic) parameters may be expressed implicitly in the following.

Electromagnetic fields (in particular, magnetic fields) can be modeled in the computational domain Ω as:
a global magnetic field hₜ comprising a first contribution h_{S} (r, t) is the magnetic field produced by the electromagnetic source Ωs and a second contribution h (to be estimated) produced by the induced eddy current j, e.g. hₜ=h_{S}+h,
a global magnetic induction field bₜ comprising a first contribution b_{S}(r, t) is the magnetic induction field produced by the electromagnetic source Ωs and a second contribution b (to be estimated) produced by the induced eddy current j, e.g. bₜ=b_{S}+b.

In this framework, it is known that, under the hypothesis of magneto quasi-static approximation, the following set of Maxwell equations that characterizes the sources of the problem hold in Ω (that is, the computational domain):

$$▽ \cdot {b}_{s} ( r , t ) = 0$$

$$▽ \cdot {j}_{s} ( r , t ) = 0$$

$$▽ \times {h}_{s} ( r , t ) = {j}_{s} ( r , t )$$

$$▽ \cdot b ( r , t ) = 0$$

$$▽ \cdot j ( r , t ) = 0$$

$$▽ \times h ( r , t ) = j ( r , t )$$

$$▽ \times e ( r , t ) - \frac{\partial }{\partial t} {b}_{t} ( r , t ) = 0.$$

$$with$$

$${b}_{t} ( r , t ) = {μ}_{0} {h}_{t} ( r , t ) , r ∈ Ω$$

$$e ( r , t ) = ρ ( r ) j ( r , t ) , r ∈ {Ω}_{c}$$

where
e(r, t) refers to the electric field (to be determined) caused by the current j (whose value is to be determined) flowing in the conductor Ω_{C},
r is a vector of radial distance from an origin (e.g., the source Ω_{S}).
Boundary conditions (e.g., at infinity for a notionally unlimited computational domain) for current density j can be expressed as:

$$j ( r , t ) \cdot n = 0 , ∀ r ∈ Γ$$

where Γ is an edge portion of the conductive device ΩC and n is an outgoing vector (radially) normal to Γ.

It is possible to express Faraday's law as:

$$\frac{\partial }{\partial t} {a}_{t} + e = - ▽ϕ$$

where:
ϕ is a scalar electric potential, and
aₜ is a magnetic vector potential that satisfies the relation bₜ=∇×aₜ

As a result, the magnetic vector potential aₜ comprises a first contribution as (r, t) produced by the electromagnetic source Ω_{S} and a second contribution a (to be estimated) produced by the induced eddy current j in the conductor Ω_{C}, e.g. aₜ=a_{S}+a.

As known to those of skill in the art, the magnetic vector potential at in space depends on the current density j according to an integral relation which can be expressed as:

$${a}_{t} ( r , t ) = \frac{{μ}_{0}}{4 π} {\int }_{Ω} \frac{{j}_{d} ( {r}^{′} , t )}{\vert r - {r}^{′} \vert} dv = 𝒢 j$$

where
G is a short note for the integral operator

$$\frac{{μ}_{0}}{4 π} {\int }_{Ω} \frac{1}{\vert r - {r}^{′} \vert} dv$$

and
dv indicates integration over the volume element of the computational domain Ω.

Observing that the current distribution j in space can be expressed as comprising a first contribution j_{S} from the source domain Ω_{S} and a second contribution j of the eddy currents in the conductor Ω_{C}, it follows that aₜ=a+a_{S}=Gj_{S}+Gj.

As a result, an Electric Field Integral Equation (EFIE) can be expressed as:

$$\frac{\partial }{\partial t} 𝒢 j + \frac{\partial }{\partial t} {a}_{s} + e = - ▽ϕ$$

As exemplified in FIG. 4, an operation (discussed in respect of block 20 of FIG. 2) of receiving (electromagnetic) input data of the electronic device P under analysis comprises:
block 200: checking the validity of the input electronic file P (e.g., checking that there is no data corruption), instructing the user to provide a new data file and waiting for it before starting processing in case of a negative check,
block 202: (e.g, in case of a positive validity check) selecting at least one mesh shape type (e.g., polygonal and/or polyhedral, such as tetrahedral, parallelepipedal, hexahedral, a mix of tetrahedra and hexahedra, etc.), and
block 204: applying (e.g., 3D) mesh generation processing, producing a mesh (represented in dashed lines and indicated with K in FIG. 3) that is a distribution of shapes (e.g., polyhedra) of the selected type(s) extending over the geometrical domain Ω_{C} of the received (electronic device model) data P; in other words, mesh generation processing comprises partitioning the geometrical volume Ω_{C} of the electronic device P in a plurality of (multifaceted, polyhedral) mesh elements.

As used herein, the term “tetrahedron element” refers to a mesh element having the shape of a triangular pyramid, while the term “hexahedron element” refers to a mesh element having a shape of a parallelepiped or of a truncated pyramid.

As currently used, the term mesh generation refers to a method of producing a subdivision of a continuous geometric space (e.g., from the CAD file P) into discrete geometric and topological cells, called mesh cells or elements. Mesh elements are used as discrete local approximations of the larger domain. Meshes are generated using mesh generations, in a manner known per se. Meshes are configured to accurately capture the input domain geometry (e.g., forming a simplicial complex) as to make local calculations of physical quantities which may vary locally in the geometry.

In one or more embodiments, blocks 202, 204 further comprises selecting also the size and number of mesh elements, which can be finely tuned for determining an accuracy of subsequent computations of physical parameters.

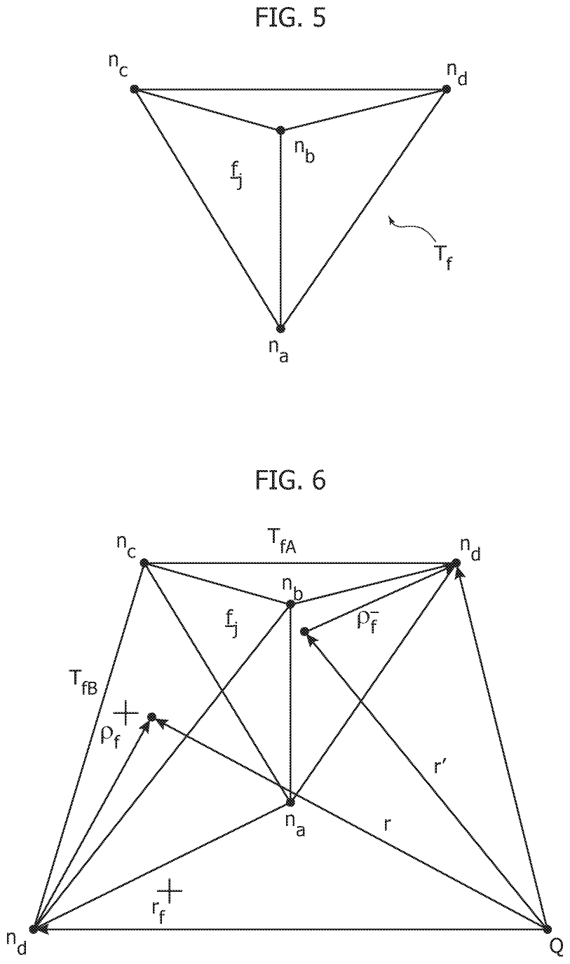

FIG. 5 is a top-view of a diagram of a mesh element T_{f} of the mesh K in one or more embodiments.

As exemplified in FIG. 5, the mesh element T_{f} has four vertex corners nₐ, n_{b}, n_{C}, n_{d} and four triangular faces (three of which visible in FIG. 5) among which a j-th face is denoted as fⱼ.

FIG. 6 shows two adjacent mesh elements (e.g., tetrahedral) T_{fA}, T_{fB} sharing a j-th face fⱼ and three vertexes nₐ, n_{b}, n_{C} of their respective vertexes.

As exemplified in FIG. 4, the operation of receiving or providing a model of an electromagnetic source S (block 22 in FIG. 1) comprises computing (or incorporating) in the mesh the electromagnetic parameters (block 220 of FIG. 4).

For the sake of simplicity, one or more embodiments are discussed considering a notionally point-like electromagnetic source S condensed in a single point at a distance r from an origin of the 3D reference system, being otherwise understood that such a kind of source is purely exemplary and in no way limiting.

In one or more embodiments, mesh generation 204 facilitates expressing the physical quantities of interest, in particular current density values j, as a sum over the mesh of functions defined locally for each mesh element.

For instance, the dependence from space and from time of the eddy current density j can be decoupled, and the eddy current density j can be expressed as:

$$j ( r , t ) = {{\sum }^{F}}_{j = 1} {w}_{{f}_{j}} ( r ) {I}_{j} ( t )$$

where
Iⱼ is a j-th face current density parametric value (whose value is to be determined) associated to the j-th face fⱼ of the mesh element T_{f},
w_{f}_{ⱼ} is a so-called basis function for a j-th face F of an h-th mesh element.

For instance, basis functions used in conventional solutions exploit Raviart-Thomas (RT) or Rao-Wilton-Glisson (RWG) functions in a manner per se known. These functions are known only for some kind of mesh elements (e.g., tetrahedra) and vary (e.g., linearly) inside the volume of the mesh element. In the PEEC or VI contexts, this may lead to increased errors when increasing an integration order (e.g., from linear to quadratic) in using numerical integration techniques known per se (such as Gauss integration, for instance).

One or more embodiments exploits a new kind of basis functions w_{f}_{ⱼ} which have a uniform, constant value for each mesh element, facilitating overcoming drawbacks in existing solutions, as discussed in the following.

As exemplified in FIG. 3, in order to numerically compute values of the current density on the meshed geometry, the so-called weak form of the EFIE can be used, which can be expressed as:

$$\frac{d}{dt} ( 𝒢 j , {j}^{′} ) + ( ρ ( r ) j , {j}^{′} ) = - \frac{d}{dt} ( {a}_{s} , {j}^{′} ) , ∀ {j}^{′} ∈ J$$

Applying the Galerkin method, in a manner known per se, and setting j′=w_{f}, the weak EFIE becomes a symmetric system of linear equations which can be expressed in matrix form as:

$$ℝ I + M \frac{d}{dt} I = - \frac{d}{dt} {A}_{s}$$

where
I is a vector comprising face current density values I₁, . . . , Iⱼ, . . . , Iₙ of all j-th faces f_j of the mesh (whose numerical value is to be determined),
R is a first matrix currently denoted as resistance matrix, which stores values indicative of resistivity of the conductor σ⁻¹(r),
M is a second matrix currently referred to as global inductance matrix which stores values indicative of the magnetic coupling between the mesh elements,

A_{S} is a vector potential matrix which stores values indicative of the magnetic vector potential generated by the sources in Ωₛ.

In a manner per se known, the system of equation of EFIE formulation can be also expressed in the frequency domain, as:

$$ℝI + i ω MI = - i ω {A}_{s}$$

where matrices R and M store values (or coefficients) that are based on basis functions Wfⱼ, as discussed in the foregoing. A product of the matrices R and M times the vector I balance the effect of the source term As. For instance, once the current values in vector I are determined, these can be postprocessed using the basis functions w_{f}_{ⱼ}(r) to reconstruct the distributed values of the respective physical parameters in the meshed structure K.

In order to link “global” matrices R, M, and source term A_{S} to each “local” mesh elements T_{f}, the so-called restriction matrix [symbol] ^{h} configured to be applied to the vector I of the currents (which are associated to faces of mesh elements) to provide a subset of (face) current values therein. For instance, current values I₁ and I₂ belong to a certain h-th volume vₕcomprising a subgroup of Fᵥ_{ₕ} of faces fⱼ^{v}^{ₕ} therein within a total number F of faces in the meshed volume V.

In other words, the restriction matrix [symbol] ^{h} for the h-th volume vₕ is a product F*Fᵥ_{ₕ}, whose elements are non-zero (and in particular, equal to 1) for the j-th face fⱼ falling within the boundaries of vₕ. It follows that the “global” or “mass” matrices R, M, and the vector A_{S}, can be expressed as:

$$ℝ = {\sum }_{h = 1}^{V} {𝕆}^{{h}^{T}} {ℝ}^{{v}_{h}} {𝕆}^{h}$$

$$M = {\sum }_{h = 1}^{V} {\sum }_{k = 1}^{V} {𝕆}^{{h}^{T}} {𝕄}^{hk} {𝕆}^{k}$$

$${A}_{s} = {\sum }_{h = 1}^{V} {𝕆}^{{h}^{T}} {A}_{s}^{{v}_{h}}$$

where:
[symbol] is the local resistivity matrix computed for the h-th volume element vₕ
M^{hk} is the local inductance or matrix computed for the h-th volume vₕ,
Aₛ^{v}^{ₕ} is the local vector potential computed for the h-th volume vₕ,
T apex denotes the transposed version of the restriction matrix.

An ij-th element of the local resistance matrix [symbol] for the h-th volume vₕ is calculated as:

$${R}_{ij}^{{v}_{h}} = {\int }_{{v}_{h}} {σ}^{- 1} ( r ) {w}_{{f}_{i}}^{{v}_{h}} ( r ) \cdot {w}_{{f}_{j}}^{{v}_{h}} ( {r}^{′} ) d {v}_{h}$$

For instance, an ij-th element of the local resistance matrix [symbol] for the h-th volume vₕ can be calculated as an integral of the product of resistivity σ times the respective basis functions in the h-th volume vₕ.

An ij-th element of the local inductance matrix Mₕₖ is calculated as:

$${M}_{ij}^{h k} = \frac{{μ}_{0}}{4 π} {\int }_{{v}_{h}} {\int }_{{v}_{k}} \frac{{w}_{{f}_{i}}^{{v}_{h}} ( r ) \cdot {w}_{{f}_{j}}^{{v}_{k}} ( {r}^{′} )}{\vert r - {r}^{′} \vert} d {v}_{h} d {v}_{k}$$

which is a double integral where, as exemplified in FIG. 5, r is the distance between an origin Q and a point of the k-th volume vₖ while r′ is the distance between the origin Q and a point of the h-th volume vₕ and where w_{f}_{ᵢ}^{v}^{ₕ}(r), w_{f}_{ⱼ}^{v}^{ₖ}(r′) are basis functions for expressing the spatial variation of the current density values J in respective volume elements in the mesh K.

An ij-th element of the local vector potential A_{S} is calculated as:

$${A}_{s , i}^{{v}_{h}} = {\int }_{{v}_{h}} {a}_{s} ( r ) \cdot {w}_{{f}_{i}}^{{v}_{h}} ( r ) d {v}_{h}$$

For the sake of simplicity, in the following the discussion is mainly focused on matrices M, R, being otherwise understood that for fully solving the problem also boundary conditions on the boundary of Ω_{c} and solenoidality of I are to be taken into account in the system of equations. For instance, this can be expressed in a matrix form as:

$$𝔻 I = 0$$

where [symbol] is the volume-faces incidence matrix, configured for taking into account the solenoidal basis for the (face) currents I, for instance.

As exemplified in FIG. 4, the operation of performing data processing of the input data P, S (block 24 of FIG. 1) comprises:
block 240: receiving the generated mesh K (blocks 202, 204, 220 of FIG. 4) and building basis functions w_{f}_{ᵢ}^{v}^{ₕ}(r) of mesh elements T_{f}, T′_{f} therein, producing a set of basis function vectors w_{f}_{ᵢ}^{v}^{₁}(r), . . . , w_{f}_{ᵢ}^{v}^{_{V}}(r) as a result, where V is the number of volume elements in the mesh,
block 242: selecting a processing stage configured to compute at least one component of a reduced mass matrix N stemming from a factorized expression of the matrix M, the processing stage selectable out of a first data processing stage 243, a second data processing 245 stage and a third data processing stage 247, wherein the selected processing stage provides as a result at least one component N_{S} of the reduced matrix N (or data N* indicative of the reduced matrix N), as discussed in the following;
block 248: providing a solution vector for the EFIE equation by exploiting matrix factoring, consequently computing a factorized matrix expression and/or, preferably, iterative solution processing (e.g., via GMRES), which facilitates limiting memory consumption and possibly reducing computational complexity.

As discussed in the foregoing, there are various types of functions which may be suitable for use as basis function w_{f}_{ᵢ}^{v}^{ₕ}(r). Depending on which basis function is used, the performance of the numerical simulation may vary appreciably. In particular, computational complexity and accuracy are based on the selection of basis function w_{f}_{ᵢ}^{v}^{ₕ}(r).

Inventors have observed that use of certain basis functions, referred to as volume uniform (briefly, VU) basis functions in the following, e.g., having a constant value invariantly within each mesh element T_{f}, can sensibly improve efficiency of computing the current density values J distributed in space and time with respect to existing methods using known basis functions.

As discussed in the following, applying VU basis functions to numerical computation and computer-aided determination of electromagnetic parameters (e.g., values and direction of eddy-current) in the conductive body (e.g., PCB circuit board) under analysis produces a more efficient technical implementation and extends design flexibility, unlocking otherwise inaccessible computational capabilities such as, for instance, accurate and effective calculation of elements of the mass matrices (and the definition and computation of a reduced matrix N, as discussed in the following).

In order to express a VU basis function, it is noted that for the (e.g., tetrahedral) mesh K, it is possible to construct a barycentric dual mesh [symbol] by considering the barycenter bᵢ of each i-th volume vᵢ of K as the dual nodes ñᵥ_{ᵢ}, i={1, . . . ,V} of [symbol] in a one-to-one, “dual” correspondence between vᵢ and ñᵥ_{ᵢ}.

The construction of this dual mesh is discussed, for instance, in document Lorenzo Codecasa, Ruben Specogna, Francesco Trevisan, “A new set of basis functions for the discrete geometric approach”, Journal of Computational Physics, Volume 229, Issue 19, 2010, Pages 7401-7410, ISSN 0021-9991, doi: 10.1016/j.jcp.2010.06.023 which discusses the so called discrete geometric approach allows to translate the physical laws of electromagnetism into discrete relations, involving circulations and fluxes associated with the geometric elements of a pair of interlocked grids: the primal grid and the dual grid.

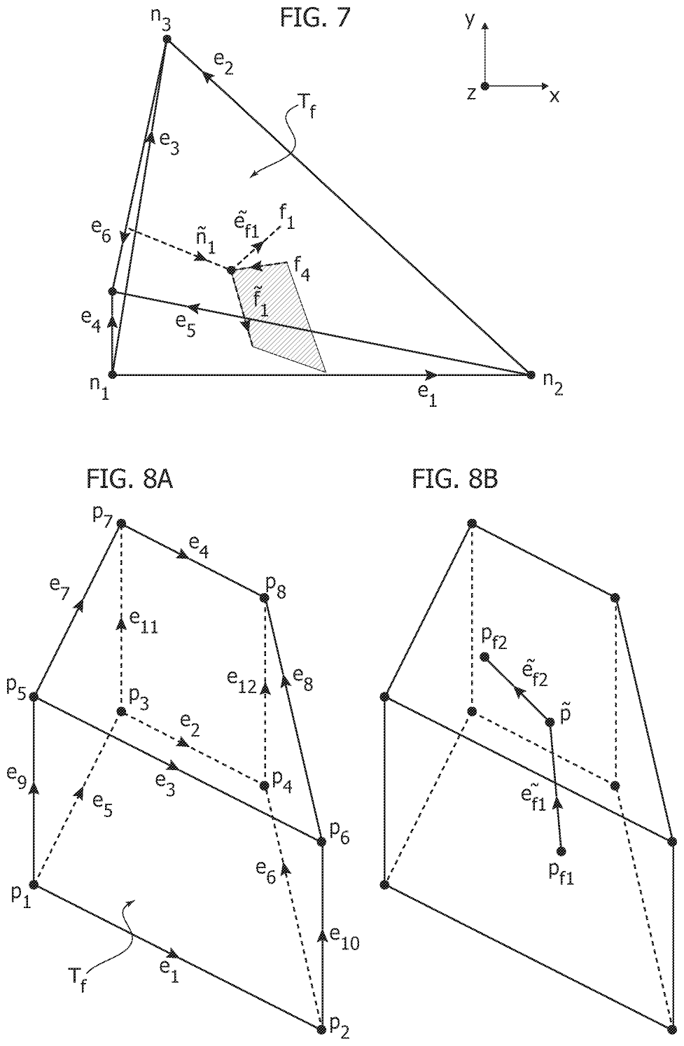

As exemplified in FIG. 7, a dual of a k-th mesh element (e.g., tetrahedral) T_{f} having volume vₖ can be defined, the dual comprising:
a set of dual edges \tilde{e}_{f} with j-th members \tilde{e}_{f}_{ⱼ}, with j={1, . . . ,F}, where dual edges (e.g., \tilde{e}₁) are configured for connecting two dual nodes (e.g., ñ₁) passing through a barycenter (e.g., b₁) of the j-th face fⱼ that is shared between vᵢ and vₕ is in a one-to-one correspondence with the j-th face fⱼ, and
a set of dual faces \tilde{f}ₑ_{ₖ} with k={1,I,E} that correspond to “primal” (that is, non-dual) edges eₖ, and
a set of dual volumes ñₙ_{ₙ} with n={1, . . . ,N} that correspond to “primal” nodes ñₙ_{ₙ}.

The definition of the dual of a mesh element T_{f} facilitates interpreting the weak EFIE in terms of an electric circuit that can be solved via network analysis methods. For instance, a graph of an electrical network is formed by dual nodes and dual edges \tilde{e}_{f} of the mesh elements T_{f} in the mesh K.

As exemplified in FIGS. 8A and 8B, also hexahedra volume elements T′_{f} are suitable for use as mesh elements in the mesh K. Preferably, hexahedral mesh elements T′_{f} are employed to analyze a PCB circuit board as conductive body Ω_{C}. For instance, with respect to tetrahedral elements T_{f}, hexahedral mesh elements T′_{f} better approximate the volume of a PCB having hexahedral (in particular, parallelepipedal) shape. In particular, hexahedra facilitate creating a “layered” mesh structure. This facilitates studying eddy current problems where the known “skin effect” plays a role.

Skin effect is the tendency of an alternating electric current (AC) to become distributed within a conductor such that the current density is largest near the surface of the conductor and decreases exponentially with greater depths in the conductor, in a manner known per se. The electric current flows mainly at the “skin” of the conductor, between the outer surface and a level called the skin depth. Skin depth depends on the frequency of the alternating current; as frequency increases, current flow moves to the surface, resulting in less skin depth.

Thus, generating a mesh structure K including a hexahedral, layered elements, increases computational efficiency and more accurately reproduces the penetration layers of the field in the conductive body Ω_{C}.

For the sake of simplicity, computation of VU basis functions Wfj is discussed herein mainly with respect to a mesh structure K including like mesh element types T_{f}, being otherwise understood that such a case is purely exemplary and in no way limiting. In one or more embodiments, VU basis functions w_{f}_{ᵢ}^{v}^{ₕ}(r) can be computed for notionally mesh elements of any (e.g., polyhedric or polygonal) shape, size (e.g., 2D or 3D) and combination of shapes/sizes thereof (such as tetrahedral and hexahedral elements suitable for use in multigrid analysis, for instance).

FIG. 8A shows a diagram of a hexahedral mesh element T′_{f} comprising six faces f₁, . . . , f₆, twelve edges e₁, . . . , e₁₂ and eight nodes p₁, . . . , p₈.

FIG. 8B shows properties of the dual mesh which can be computed for the hexahedral element T′_{f}.

As exemplified in FIG. 8b, the coordinates of the nodes of the hexahedron in FIG. 7 can be expressed in the 3D cartesian system of axes x,y,z by tuple of values, e.g.: p₁=(0,0,0), p₂=(2,0,0), p₃=(0,1,0), p₄=(1,1,0), p₅ =(0,0,1), p₆=(2,0,1), p₇=(0,1,1), p₈=(1,1,1).

Correspondingly, a barycenter p_{f}_{ᵢ} of an i-th face fᵢ of the mesh element T′_{f} and the corresponding dual edge \tilde{e}ᵢ with i=1, . . . ,F while \tilde{p} refers to a dual node of the element T′_{f}.

As discussed herein, a VU basis function w_{f}_{ᵢ}^{v}^{ₖ}(r) having as “support” the union of volumes vₕ and vₖ adjacent to i-th face fᵢ can be expressed, for each of the volumes vh, vk, as:

$${w}_{{f}_{j}}^{{v}_{k}} ( r ) = \frac{1}{\vert {v}_{k} \vert} ( {b}_{{f}_{j}} - {\tilde{n}}_{{v}_{j}} ) = \frac{1}{\vert {v}_{k} \vert} {\tilde{e}}_{{f}_{j}} , r ∈ {v}_{j} , j ∈ \{ h , k \}$$

where
vₖ is the volume of a k-th mesh element T_{f}, T′_{f},
\tilde{e}_{f}:=b_{f}−ñᵥ_{ₖ} is the vector part of the basis function, for which the following equality holds:

$$j = \frac{1}{\vert {v}_{k} \vert} {\sum }_{f ∈ \partial {v}_{k}} {I}_{f} {\tilde{e}}_{f}$$

In one or more embodiments, VU basis functions

$${w}_{{f}_{j}}^{{v}_{k}} ( r ) = \frac{1}{\vert {v}_{k} \vert} {\tilde{e}}_{{f}_{j}}$$

have a value which is the same irrespective of which point inside the k-th volume is taken as starting point for their computation. In this sense, they can be considered “uniform” (that is, invariant) inside the internal volume of any (e.g., polyhedral, tetrahedral, hexahedral, etc.) mesh elements T_{f}, T′_{f}.

As exemplified in FIG. 4, performing the operating of computing ij-th values of mass matrices R, M 240 may be computationally simplified as respective elements may be computed as follows:

$${R}_{i j}^{{v}_{k}} = {\int }_{{v}_{k}} {w}_{{f}_{i}}^{{v}_{k}} ( r ) \cdot {𝕂}_{η} {w}_{{f}_{j}}^{{v}_{k}} ( r ) {dv}_{k} = \vert {v}_{k} \vert {w}_{{f}_{i}}^{{v}_{k}} ( r ) \cdot {𝕂}_{η} {w}_{{f}_{j}}^{{v}_{k}} ( r )$$

$${M}_{ij}^{hk} = \frac{{μ}_{0}}{4 π} {\int }_{{v}_{h}} {\int }_{{v}_{k}} \frac{{w}_{{f}_{i}}^{{ν}_{h}} ( r ) \cdot {w}_{{f}_{j}}^{{ν}_{k}} ( {r}^{′} )}{\vert r - {r}^{′} \vert} {dv}_{h} {dv}_{k} = {t}^{hk} {w}_{{f}_{i}}^{{v}_{h}} ( r ) \cdot {w}_{{f}_{j}}^{{v}_{k}} ( {r}^{′} ) , with r ∈ {v}_{h} , {r}^{′} ∈ {v}_{k} and {t}^{hk} = \frac{{μ}_{0}}{4 π} {\int }_{{v}_{h}} {\int }_{{v}_{k}} \frac{1}{\vert r - {r}^{′} \vert} {dv}_{h} {dv}_{k}$$

Conventional method for solving eddy current problems using the (weak) EFIE formulation as discussed in the foregoing, suffer at least two main drawbacks:
the inductance mass matrix M is fully populated and thus computationally expensive to compute and store in memory,
the double integral to compute the inductance mass matrix M is singular (that is, it goes to infinity for r=r′ whenever vₕ=vₖ, namely for all the diagonal terms of mass inductance matrix M) and only analytical solutions can overcome this singularity.

Selecting VU basis functions w_{f}_{ⱼ}^{v}^{ₖ} which are invariant from the point inside the k-th volume vₖ in which they are calculated as per the present disclosure reduces complexity of calculations, where the VU basis functions can be expressed as:

$${w}_{{f}_{j}}^{{v}_{k}} ( r ) = \frac{1}{\vert {v}_{k} \vert} {\tilde{e}}_{{f}_{j}} .$$

For instance, the singular double integral tₕₖ can be taken out of the expression of the ij-th matrix element Mᵢⱼ^{hk}.

It is noted that computing the double integral t^{hk} as a term independent of the variation over vₕ and vₖ is possible thanks to the selected VU basis functions Wfⱼ, while using conventional RT and RWG basis functions this is not possible.

The possibility of computing the double integral as a term isolated with respect to the product of basis functions Wfⱼ facilitates exploiting analytic expressions or closed-form formulas to compute the innermost integral, possibly eliminating the singularity problem.

As exemplified in FIG. 4 in block 240, by making use of VU basis functions w_{f}_{ⱼ}^{v}^{ₖ}(r) to perform interpolation processing for each element and on the basis of the generated/received mesh K, the processing system 10 carries out the integration computation using solely numerical integration, like one adopting a hybrid Gauss integration method, or a hybrid integration method.

Specifically, thanks to the use of VU basis functions w_{f}_{ⱼ}^{v}^{ₖ}(r) the double integral term t^{hk} may be solved using hybrid numerical and analytical techniques, where a first integral is computed numerically and a second integral is computed analytically, in a manner per se known, e.g. from documents R. A. Werner, D. J. Scheeres, “Exterior gravitation of a polyhedron derived and compared with harmonic and mascon gravitation representations of asteroid 4769 castalia,” Celestial Mechanics and Dynamical Astronomy 65 (3) (1997). doi: 10.1007/bf00053511.

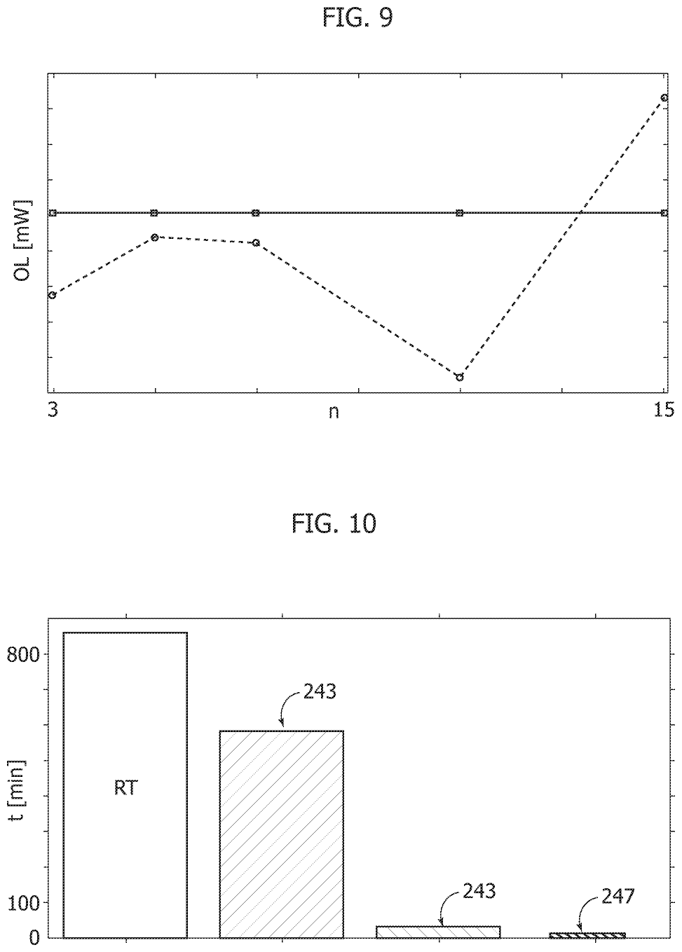

FIG. 9 is a plot of ohmic losses OL (ordinate scale, in milliWatt) versus an increasing integration order precision computed for tetrahedral mesh (abscissa scale), comparing results obtained when using conventional basis functions (e.g., RT or RWG, in dashed line) with those obtained using VU basis functions Wfⱼ (in solid line).

As exemplified in FIG. 9, convergence of the numerical analysis shows an improved stability thanks to the possibility to apply analytic methods (e.g., singularity extraction technique, known per se) with respect to solely applying numerical approximations.

For the sake of computational stability, a further computational matrix referred to as “stabilization matrix” may be introduced as discussed, e.g., in document M. Passarotto, R. Specogna and F. Trevisan, “Novel Geometrically Defined Mass Matrices for Tetrahedral Meshes,” in IEEE Transactions on Magnetics, vol. 55, no. 6, pp. 1-4, June 2019, Art no. 7200904, doi: 10.1109/TMAG.2019.2893692 which introduces a method for constructing mass matrices for general tetrahedral elements. By considering the construction of the reluctivity mass matrix as an example, a derivation of a recipe to geometrically construct a symmetric positive semi-definite and consistent mass matrix is provided. It is shown why such a matrix can be used inside formulations where the mass matrix is right multiplied by the appropriate incidence matrix.

As exemplified herein, a symmetric positive semidefinite matrix stabilization matrix Sᵥ_{ₖ} for volume vₖ with a number m of faces, can be expressed as:

$$\begin{matrix}1. {S}^{k} {𝔽}_{{v}_{k}} = 𝕆 \\ 2. rank ( {S}^{k} ) = m - 3\end{matrix}$$

where:
[symbol] ᵥ_{ₖ} is a matrix of size (m×3) having face vectors associated with the volume vk as items (e.g., rows),
[symbol] is a matrix mapping the local geometrical elements (that is, referred to a h-th mesh volume vₕ) to global ones (that is, referred to mesh structure K)

A stabilized resistance k-th matrix element can be expressed as [symbol] = [symbol] +S^{k} so that the stabilized mass resistance matrix [symbol] ₛ can be expressed as:

$${ℝ}_{s} = {\sum }_{k = 1}^{V} {𝕆}^{{k}^{T}} {ℝ}_{s}^{k} {𝔻}^{k}$$

A hk-th matrix element M^{hk} of a stabilized mass inductance Mₛ can be expressed as

$${M}_{s}^{hk} = \{ \begin{matrix}{M}^{hk} + {S}^{k} if h = k \\ {M}^{hk} if h \neq k\end{matrix}$$

so that the stabilized mass inductance matrix becomes:

$${M}_{s} = {\sum }_{h = 1}^{V} {\sum }_{k = 1}^{V} {𝕆}^{{h}^{T}} {M}_{s}^{hk} {𝕆}^{k}$$

Inventors have observed that using a sparse stabilization matrix S with non-zero diagonal elements (only) can be a relevant feature to express the inductance matrix M as a factorized expression.

For the sake of simplicity, one or more embodiments are discussed in the following generally referring to the global mass-matrix M, being otherwise understood that one or more embodiments can be applied mutatis mutandis to a global stabilized mass-matrix Mₛ that can be expressed as Mₛ=M+S, where S is a global (sparse) stabilization matrix.

As exemplified in FIG. 4, block 240 further comprises storing selected basis functions in respective matrices [symbol] ₓ, [symbol] _{y} and [symbol] _{z} comprising sparse basis matrices each of size E_{B}×V where E_{B} is a number of “blossomed” (that is, split) edges for each h-th volume vₕ of mesh K. The latter include, e.g., all edges of the mesh not shared between two or more volumes; for instance, in a simplicial mesh E_{B}=6*V.

As used herein, the term “sparse matrix” refers to a matrix in which most of the elements are zero.

Specifically, basis matrices Eₓ, E_{y} and E_{z} has one non-zero term per item (e.g., row), the non-zero element equal to the value of the considered component of the VU basis function Wfⱼ in that primal edge (e.g.,

$$\frac{1}{\vert {v}_{k} \vert} {\tilde{e}}_{{f}_{j}} ) .$$

For instance, the matrix [symbol] stores (e.g., as column vectors) the vectors associated with the restriction of dual edges to k-th volume element vₕ, namely \tilde{e}ⱼ^{v}^{ₕ} with j=1, . . . ,F^{v}where F^{v}^{ₕ} is the number of faces of the polyhedron T_{f} in the mesh structure K.

Extending this to the 3D structure of the mesh K, for instance, the basis matrices for each axis of the 3D Cartesian space can be expressed as:

$$\begin{matrix}{\tilde{𝔼}}_{x}^{{v}_{h}} = \hat{x} {\tilde{𝔼}}^{{v}_{h}} \\ {\tilde{𝔼}}_{y}^{{v}_{h}} = \hat{y} {\tilde{𝔼}}^{{v}_{h}} \\ {\tilde{𝔼}}_{z}^{{v}_{h}} = \hat{z} {\tilde{𝔼}}^{{v}_{h}}\end{matrix}$$

where \hat{x}=(1,0,0), ŷ=(0,1,0) and \hat{z}=(0,0,1) are Cartesian unit vectors.

Starting from these local basis vectors, a set of global basis matrices [symbol] ₓ, [symbol] _{y} and [symbol] _{z} can be produced, for instance stacking local basis matrices [symbol] ₓ^{v}^{ₕ}, [symbol] _{y}^{v}^{ₕ} [symbol] as items (e.g., rows) the global matrices [symbol] ₓ, [symbol] _{y} and [symbol] _{z}.

For instance, the global basis function matrix (e.g., [symbol] ₓ) can be computed as a matrix having h-th diagonal element equal to the h-th local basis function matrix (e.g., [symbol] ) with index h=1,2, . . . ,V. For instance, a first (e.g., horizontal) global function matrix [symbol] ₓ can be expressed as:

$${\tilde{𝔼}}_{x}^{T} = ( \begin{matrix}[ \begin{matrix}{{{\tilde{𝔼}}_{x}^{{v}_{1}}}^{⋮}}_{⋮}\end{matrix} ] & ⋯ & 0 \\ ⋮ & ⋱ & ⋮ \\ 0 & ⋯ & [ \begin{matrix}{{{\tilde{𝔼}}_{x}^{{v}_{V}}}^{⋮}}_{⋮}\end{matrix} ]\end{matrix} )$$

In one or more embodiments, basis function matrices [symbol] ₓ, [symbol] _{y}, [symbol] _{z} comprise sparse matrices which can be computed relatively quickly and stored with a reduced memory footprint with respect to conventional solutions.

This may facilitate reaching an appreciable speedup of performances, theoretically up to 36× (thirtysix times) using tetrahedral mesh elements and 144× (hundredfourtyfour times) using hexahedra mesh elements.

As mentioned, existing methods present a bottleneck in computing the mass matrix M as it is a matrix of size equal to the product of face elements F*F and full of non-zero (coefficient) values.

Conversely, using VU basis functions Wfⱼ, Eₓ, E_{y}, E_{z} as discussed in the foregoing, the global inductance matrix M can be expressed as:

$$M = {𝕆}_{{F}_{B}}^{T} ( {\tilde{𝔼}}_{x}^{T} N {\tilde{𝔼}}_{x} + {\tilde{𝔼}}_{y}^{T} ℕ {\tilde{𝔼}}_{y} + {\tilde{𝔼}}_{z}^{T} N {\tilde{𝔼}}_{z} ) {𝕆}_{{F}_{B}}$$

where:
[symbol] _{x,} [symbol] _{y} and [symbol] _{z} are sparse matrices of size V×F_{B}, comprising at most one non-zero term per entry (e.g., column), that is the correspondent value of the considered component of the face basis function associated to that primal face, where F_{B} is the total number of blossomed faces that are obtained for each considered volume of mesh K, e.g., by repeating the faces of the mesh as they were not shared between two volumes, for instance a simplicial mesh F_{B}=4V, and
[symbol] _{F}_{_{B}} is the global restriction matrix of size F_{B}×F, the restriction matrix configured to map blossomed faces F_{B} to the “actual” F faces of the mesh elements Tf, wherein the restriction matrix is also a sparse matrix having at most one non-zero, unitary term per entry (e.g., column).

In one or more embodiments, producing 240 sparse basis matrices [symbol] ₓ, [symbol] _{y} and [symbol] _{z} may comprise computing a curl of the basis functions Wfⱼ. For a mesh K of polyhedra elements T_{f}, T′_{f}, this may involve performing computation thereof in the local discrete framework, obtaining the respective global matrices therefrom. For instance, local basis function matrices [symbol] , [symbol] , [symbol] for an h-th volume element vₕ can be expressed as:

$$\begin{matrix}{𝔼}_{x}^{{v}_{h}} = {ℂ}^{{v}_{h}^{T}} \hat{x} {\tilde{𝔼}}^{{v}_{h}} \\ {𝔼}_{y}^{{v}_{h}} = {ℂ}^{{v}_{h}^{T}} \hat{y} {\tilde{𝔼}}^{{v}_{h}} \\ {𝔼}_{z}^{{v}_{h}} = {ℂ}^{{v}_{h}^{T}} \hat{z} {\tilde{𝔼}}^{{v}_{h}}\end{matrix}$$

where:
\hat{X}, ŷ, \hat{z} are unitary cartesian coordinate vectors, namely \hat{x}=(1,0,0)^{T}, ŷ=(0,1,0)^{T} and \hat{z}=(0,0,1)^{T};
[symbol] is a local faces-edges matrix associated to the local faces F^{v}^{ₕ} and local edges E^{v}^{ₕ} of an h-th volume element vₕ,
[symbol] is a dual edge matrix having as matrix items (e.g., rows) dual edges \tilde{e}ₕ^{v}^{ₕ}, j=1, . . . ,F^{v}^{ₕ} of the F^{v}^{ₕ} local faces of the polyhedral volume element vₕ, that is an “unnormalized” part of the VU basis functions.

In order to facilitate matrix computation processing (block 24 of FIG. 1), analysis may be performed in the frequency domain.

Exploiting cohomology theory, in a manner known per se to those of skill in the art, the system of equations of the EFIE in the frequency domain can be multiplied by a matrix C, that is a matrix of a cohomological basis (known per se). Consequently, the system of equations to be computationally solved may thus be equivalently expressed as:

$${ℂ}^{T} ( ℝ + iω M ) I = - i {ωℂ}^{T} {A}_{s}$$

As a result, the resistivity R and inductance M mass matrices can be expressed as a single complex matrix [symbol] which can be expressed as

$$𝕂 = {ℂ}^{T} ( ℝ + i ω M ) ℂ = {𝕂}_{R} + i ω {𝕂}_{M}$$

where
ω is an angular frequency at which the eddy current problem is analyzed,
[symbol] is a cohomological basis known per se,
apex T denoted the transposed version of a matrix.

It is possible to plug the factorized expression of M into the equation above in order to obtain a factorized expression of the EFIE problem by means of the matrix M and of the sparse matrices storing the three components of the VU basis functions [symbol] ₓ, [symbol] _{y} and [symbol] _{z}.

For instance, using the same factorized expression of M, also the system of equations for the solution of EFIE in a not-simply-connected domain can be directly obtained as a factorized expression in terms of [symbol] , [symbol] ₓ, [symbol] _{y} and [symbol] _{z}. In this exemplary case, the current I presents an additional non-local term I=I_{old}+ [symbol] i expressed by means of an additional cohomological basis W. For instance, by substitution, also this case can be treated exploiting factoring of the further (already-factorized, product) term M*W.

See, for instance, document P. Dlotko, R. Specogna, Physics inspired algorithms for (co)homology computations of three-dimensional combinatorial manifolds with boundary, Computer Physics Communications 184 (10) (2013) 2257-2266. doi: 10.1016/j.cpc.2013.05.006 which discusses computing (co)homology generators of a cell complex, presenting a physics inspired algorithm for first cohomology group computations on three-dimensional complexes, where lazy cohomology generators W= [symbol] H are employed in the physical modeling of magneto-quasistatic problems.

Once elements of the complex matrices K are computed, the current density distribution J object of the electromagnetic analysis can be obtained by solving a linear system of equations, for instance K a=b, where a is a “solution” vector with values that are to be determined, b is the vector with the known term and K is the complex mass matrix.

As discussed in the foregoing, calculation and memorization of the elements of the matrix K using existing techniques can be challenging. For example, when the computational domain Ω is divided (that is, meshed 202, 204) into a million hexahedra, the number of (linear) equations in the system reaches a number equal to the number of the edges of the hexahedra T_{f}, which is in a range 3 to 4 times the number of the hexahedra V. In the example considered, storing K uses sixteen tera values (1 tera equal to 1000 billion) corresponding to a memory footprint about 256 Terabytes (a complex number of 16 bytes for each element). In the exemplary case considered, this takes up space of multiple (server) computing systems that provide about 256 gigabytes of respective storage space.

In particular, complexity of a numerical simulation increases with the number of degrees of freedom (DoFs) of the problem. The term DoFs currently refers to the number of parametric values to be determined to solve the system (e.g., the size of vector a that solves the system Ka=b). In the case considered, for instance, DoFs are proportional to number of edges in the mesh structure K.

As exemplified in FIG. 4, one of compression stages 243, 244, 245 can be selected to produce a matrix N with a reduced size with respect to that of the full inductance matrix M, for instance a size equal to V*V where V is the number of mesh elements T_{f} in the mesh K. For instance, if the mesh elements are hexahedra T_{f}, matrix N has a size which is about sixteen times lower than matrix M which is computed for each face fⱼ.

For instance, using VU basis functions in block 240 facilitates factoring the complex mass matrix K (and/or of the inductance matrix M) based on a product of the reduced matrix [symbol] and basis function matrices [symbol] ₓ, [symbol] _{y} and [symbol] _{z} (and other matrices, as discussed in the foregoing) that have a reduced memory footprint (and are computationally less burdensome to obtain) with respect to the complex mass matrix [symbol] .

As exemplified herein, it is notionally possible to compute the inductance matrix K_{M} using a factorized expression thereof. This can be based on a product of matrices including the reduced matrix N and the basis function matrices [symbol] ₓ, [symbol] _{y} and [symbol] _{z}, which can be expressed as:

$${𝕂}_{M} = {𝕆}_{{E}_{B}}^{T} ( {𝔼}_{x}^{T} {ℕ𝔼}_{x} + {𝔼}_{y}^{T} {ℕ𝔼}_{y} + {𝔼}_{z}^{T} ℕ {𝔼}_{z} ) {𝕆}_{{E}_{B}}$$

where [symbol] _{E}_{_{B}} is a sparse global restriction matrix having size DoFs×E_{B}configured for mapping the blossomed E_{B} edges into the DoFs of the mesh K; specifically, the sparse global restriction matrix [symbol] _{B} has one non-zero, unitary, term per item (e.g., row).

For instance, an alternative factorized expression takes into account the possible presence of the stabilization matrix [symbol] :

$${𝕂}_{M} = {𝕆}_{{E}_{B}}^{T} ( {𝔼}_{x}^{T} {ℕ𝔼}_{x} + {𝔼}_{y}^{T} {ℕ𝔼}_{y} + {𝔼}_{z}^{T} ℕ {𝔼}_{z} ) {𝕆}_{{E}_{B}} + {ℂ}^{T} 𝕊ℂ$$

where S is the sparse global stabilization matrix which can be expressed as

$$𝕊 = {\sum }_{k = 1}^{V} {𝕆}^{{v}_{k} T} {𝕊}^{{v}_{k}} {𝕆}^{{v}_{k}}$$

In one or more embodiments, the (eddy) current density distribution j can be computed more quickly, in a more computationally efficient manner and with a reduced memory footprint as a result of obtaining the reduced matrix N or at least a component thereof (e.g., diagonal N_{D}), as discussed in the following.

As exemplified in FIG. 4, block 242 comprises selecting one of a first 243, second 245 or third 247 processing stage based on system preferences, in particular based on available computational resources of the system 10. For instance, the first processing stage 243 is preferred when memory storage 14 is a relative constraint, while second or third processing stages 245, 247 are preferred when memory constraints are tighter. In addition, or in alternative exemplary cases, the first processing stage 243 may be selected when the degree of complexity of the problem is limited, e.g., when mesh structure K comprises a relatively low number of elements while the second 245 or the third 247 processing stages are used when the degree of complexity of the problem is relatively high, e.g., when the mesh structure K comprises some tens of thousands of mesh elements. In some exemplary cases, it may be possible to perform a same computation using each of the available processing stages 243, 245, 247, and comparing then results obtained with different methods, providing more robust simulation results.

For instance, the first, e.g., lossless compression, processing stage 243 may comprise:
block 2430: computing elements of the reduced mass matrix N and storing the computed matrix N into memory circuit 14,
block 2432: retrieving the reduced matrix N (from memory 14) and performing a vector product of the reduced matrix N times the face current vector I (comprising parametric values x, y to be determined), producing a seed or test (solution) vector I_{N} having test parametric values. For instance, assuming that α and β are test numerical values and assuming a dummy case of a matrix N having size two, a candidate seed vector I_{N} may be expressed as e.g. I_{N}=N*I=(1,1;2,2)*(x,y)^{T}=(α+β, 2α+2β).

It is noted that the first compression stage 243 uses a reduced memory area as only the component (e.g., diagonal N_{D}) of the reduced matrix N is to be retrieved from memory to perform computation. This memory compression is possible without any loss of accuracy (hence, lossless compression) of the values of the computed reduced matrix [symbol] .

As exemplified in FIG. 4, the reduced matrix N output from the first processing stage 245 is a symmetric matrix, so that a further memory reduction can be provided by storing half of it in block 2450 and exploiting properties of symmetric matrices to produce the seed vector I_{N} in block 2452.

As exemplified in FIG. 4, the first processing stage 243 provides the seed vector I_{N} to block 248 which, iteratively, “plants” therein a set of candidate values for the parametric values x, y of the seed vector I_{N} and checks whether “plugging” the candidate parametric values α,β as the face current vector I candidate values satisfy the relation expressed by the EFIE equation. This iterative solution is possible taking into account the factorization of the mass matrix K_{M}, M (that is, the factorized expression thereof) based on basis function matrices Eₓ, E_{y}, E_{z} and the reduced matrix N.

At least notionally, it may be possible to compute the full matrix K_{M}, M from its factorized expression based on N and Eₓ, E_{y}, E_{z}. At the same time, it is computationally less cumbersome to perform matrix-by-vector products, which reduce complexity, in place of matrix-by-matrix products, which increase complexity and are memory-hungry to store the fully populated matrix.

It is noted that iterative processing 248 is only one computationally advantageous way of solving the EFIE taking into account the factorized expression of the mass matrix K_{M}, M based on basis function matrices and the reduced matrix N, being otherwise understood that a reduced memory footprint may be obtained thanks to the use of a reduced matrix N also using other suitable methods.

In one or more embodiments, a generalized minimal residual processing (briefly, GMRES) may be suitable for use in block 248. GMRES is otherwise known to those of skill in the art, which makes it unnecessary to provide a more detailed description herein.

Inventors have observed that a further compression of the memory occupancy of the reduced matrix N can be provided by noting that the reduced matrix N can be expressed as the sum of a first sparse component N_{S} (e.g., [symbol] _{S}=diag( [symbol] )) and a dense component N_{D}, e.g., [symbol] _{D}= [symbol] −diag( [symbol] ), e.g., [symbol] = [symbol] _{S}+ [symbol] _{D}, so that a matrix comprising at least the sparse component N_{S} of the reduced matrix, optionally including also some terms close to the diagonal, can be used to solve the EFIE equation without incurring in drastic reduction of accuracy.

Accordingly, also the seed vector I_{N} can be expressed as having a first seed vector component Ins and a second seed vector component I_{ND}, e.g., [symbol] ·I_{N}=( [symbol] _{S}+ [symbol] _{D})·I=I_{NS}+I_{ND}.

As exemplified in FIG. 4, a second, e.g., lossy, processing stage 245 comprises:
block 2450: pre-computing and storing into the memory circuit 14 the elements of the first sparse component N_{S} of the reduced matrix N, optionally further including some off-diagonal terms, e.g., in the proximity of the diagonal.
block 2452: retrieving from memory the stored first sparse component N_{S} of the reduced matrix N, computing the first seed vector component I_{NS} by calculating the product of the vector I times the first sparse component N_{S}, computing the second seed component I_{ND} using an analytic approximation method (e.g., fast multipole method), and obtaining the seed vector I_{N} as the ensemble of the first sparse component I_{NS}, computed in a term-by-term way, and the second dense component I_{ND}, computed in an analytic way.

In one or more embodiments, fast multipole method (FMM) is a suitable (analytic) approximation processing for use in the second processing stage (block 2450). FMM is a numerical technique configured to speed up computation of long-ranged forces in an n-body problem, by expanding the system Green's function using a multipole expansion and facilitating to treat as a single source groups of sources that lie close together.

Unless the context indicates otherwise, FMM processing (and its operation) are conventional in the art and a corresponding detailed description is not provided herein for brevity.

In one or more embodiments, an hk-th element t^{hk} or n^{hk} of the reduced matrix N volume integral can be expressed as:

$${n}^{hk} = {t}^{hk} = \frac{{μ}_{0}}{4 π} {\int }_{{v}_{h}} {\int }_{{v}_{k}} \frac{1}{\vert r - {r}^{′} \vert} {dv}_{h} {dv}_{k}$$

In one or more embodiments, an off-diagonal element t^{hk} or n^{hk} for h≠k, can be approximated as:

$${n}^{h k} \approx \frac{{μ}_{0}}{4 π} \frac{\vert {v}_{h} \vert \vert {v}_{k} \vert}{\vert {r}_{{g}_{h}} - {r}_{{g}_{k}}^{′} \vert}$$

where r_{g}_{ₕ}, r′_{g}_{ₖ} are the coordinates of the barycenters of respective volume elements vₕ, vₖ.

FMM processing can thus be exploited for the approximate calculation of off-diagonal elements of the reduced matrix N. As mentioned, FMM may facilitate limiting memory footprint to that used to store the sparse component N_{S} of the reduced matrix N.

As exemplified in FIG. 10, applying FMM processing to compute the reduced matrix N it is possible to reduce the memory occupation sensibly below an average size (e.g., 256 Gigabytes) of the data storage 14.

It is noted that applying FMM to the complex mass matrix K_{M} suffers from various drawbacks, in particular increasing computation complexity. Conversely, applying FMM processing 245 to compute the reduced matrix N facilitates direct application of libraries of processing elements that can work on highly parallel processors (such as GPUs, for instance), reducing computational time.

Inventors have observed that a further compression of the memory occupancy of the reduced matrix N can be provided by exploiting alternative data formats, e.g., metadata or other object formats, to store the terms of the reduced matrix, which may be expressed as a data structure N*.

As exemplified in FIG. 4, a third, e.g., alternative, lossy, processing stage 247 comprises:
block 2750: pre-computing and storing into the memory circuit 14 the data structure N* indicative of the reduced matrix N;
block 2472: retrieving the data structure N* from memory 14 and using it to generate the seed vector I_{N} using an algebraic approximation method (e.g., adaptive cross approximation), obtaining the seed vector I_{N} as a result.

In one or more embodiments, an adaptive cross approximation (briefly, ACA) processing is suitable for use as algebraic approximation processing in block 2472.

ACA processing is conventional in the art and a corresponding detailed description is not provided herein for brevity.

For instance, using ACA in the third compression stage 247 facilitates:
storing a compressed hierarchical expression in the data storage device 14 in place of a pre-computed matrix as for FMM compression, and
tuning a level of approximation in the computation of double integral terms.

It is noted that the subdivision of the processing of computing the solution vector I for the (weak) EFIE equation 242, 243, 245, 247, 248 can be operated in stages, that is logic modules or hardware corresponding to operations 240, 242, 244, 246, 248, being otherwise understood that such a representation is purely illustrative and not limiting. In variant embodiments, also operations discussed in relation to a certain block 242, 243, 245, 248 could be performed in another block within the processing system 10 and/or the solution vector I data could be processed in an iterative way, for instance exchanging data back and forth across single blocks until the processing converges to a solution.

It is further noted that the processing system 10 may comprise one or more memory areas or memory devices 14 (for example, databases) in which to store one or more sets of data, which comprise, for example, the reduced matrix N and the VU basis matrices, e.g., processed during application of the method as exemplified herein. For instance, an operation of computing 2430, 2450, 2470 the reduced matrix N or a compressed version N_{S}, N* thereof becomes redundant after the first computation thereof, as the data is already stored in memory. This may facilitate reducing computational complexity and applying a data re-use approach.

FIG. 10 is a diagram exemplary of measured computational times for solving a same electromagnetic problem using the method as per the present disclosure.

As exemplified in FIG. 10, selecting VU basis functions facilitates reducing a computation time with respect to selecting known RT basis functions, for instance taking about 30% less time.

As exemplified in FIG. 10, selecting VU basis functions 240 together with a processing stage 243, 245, 247 can further reduce this computational time, that is increasing the computational speed of the system 10.

As exemplified in FIG. 10, lossless compression 243 reduces computational time about 96% with respect to selecting known RT basis functions.

As exemplified in FIG. 10, lossy compression 245, 247 reduces computational time about 99% with respect to selecting known RT basis functions.

As exemplified in FIG. 4, the method comprises (block 262) computing a current density distribution J solving the (weak) EFIE system of linear equations based on the computed mass matrices M, R or [symbol] _{R}+iω [symbol] _{M} in the time domain or in the frequency domain.

As exemplified in FIG. 4, the method comprises (block 280) optionally applying post-processing to the current density J, obtaining electromagnetic parameters of the analyzed conductive body Ω_{C}, e.g., ohmic losses OL in the conductive body due to eddy currents J (e.g., OL=σ⁻¹J²), spatiotemporal distribution of the electromagnetic-field E. For instance, a determination as to whether or not to carry out the various kinds of post-processing 280 is based on user preferences set via the input apparatus 13.

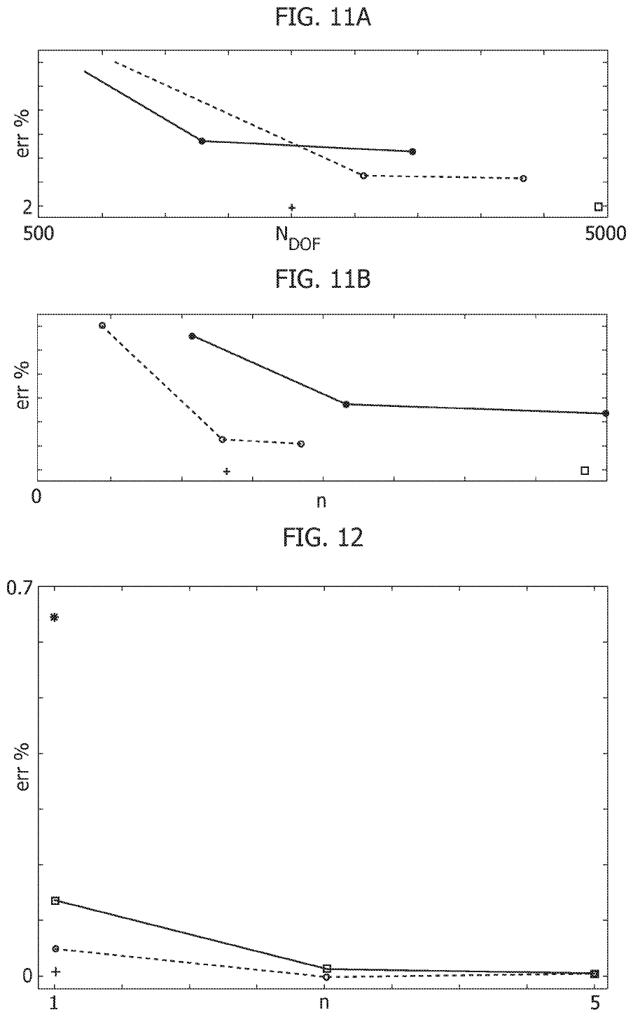

As exemplified in FIG. 11A and FIG. 11B, a comparison of error values (in percentage units, on the ordinate axis) of computed ohmic losses with respect to expected values on different mesh types and versus number of mesh elements (on the abscissa axis) shows that the error percentage can be reduced (almost to negligible) in several scenarios using the method as per the present disclosure.

FIG. 11A (and FIG. 11B) represents variation of error percentage vs number of DoFs (and vs number of mesh elements, respectively) for a variety of mesh scenarios. As exemplified in FIGS. 11A and 11B, for instance:
a solid line with solid dots represents the case of generating a mesh K comprising solely tetrahedral mesh elements T_{f},
a solid line represents the case of generating a mesh K comprising solely tetrahedral mesh elements T_{f},
a dashed line represents the case of generating a mesh K comprising only polyhedral mesh elements,
a cross-shaped point represents the case of generating a mesh K comprising solely hexahedral (e.g., parallelepiped) mesh elements T′_{f},
a square-shaped point represents the case of generating a mesh K with a variety of different mesh elements, e.g., hexahedral T′_{f} and tetrahedral T_{f} elements.

As exemplified in FIG. 12, an error percentage of the solution provided via the computational method as per the present disclosure versus an expected solution may be reduced with increasing integration order in various scenarios.

FIG. 12 represents variation of error percentage vs Gaussian integration order (e.g., quadrature) for a variety of mesh scenarios. As exemplified in FIG. 12, for instance:
a solid line with square-shaped points represents the case of generating a mesh K comprising solely tetrahedral mesh elements T_{f} and wherein singularity extraction technique is applied to the computation of double integral values,
a solid line with circle-shaped points represents the case of generating a mesh K comprising only polyhedral mesh elements and wherein singularity extraction technique is applied to the computation of double integral values,
an asterisk-shaped point represents the case of generating a mesh K comprising solely tetrahedral mesh elements T_{f} and without applying the singularity extraction technique to the computation of double integral values,
a plus-shaped point represents the case of generating a mesh K with polyhedral mesh elements and without applying the singularity extraction technique to the computation of double integral values.

As exemplified in FIGS. 1 and 4, the current density distribution J and/or other parameters may be displayed, e.g., via display 12, for instance superimposed onto the mesh geometry in an image-like format. For instance, the display 12 carries out frequency-characteristic display processing (block 280) to display the frequency characteristic of the impedance on the display 12, e.g., when block 262 outputs a frequency characteristic of the impedance.

For instance, the user observes (via the display 12) at the impedance frequency characteristic U. In one aspect, based on the observation of U, the user can determine whether or not it is necessary to further compute a variety of distributions and display the further computed distributions (e.g., clicking on a dedicated button displayed on the display apparatus 12, the button configured to activate carrying out the processing of steps 262, 280).

It is noted that, while discussed mainly with reference to determining point-by-point values of a spatiotemporal current density distribution J, e.g., induced via eddy currents, in an electromagnetically conductive body, this is in no way limiting as a method according to the present disclosure may be applied in a variety of contexts. These contexts include, at least notionally, any scenario in which a linearized problem or a problem involving vector fields has to be solved interpolating functions for calculating integral equations on a meshed structure.

In particular, one of these contexts comprises solving an EFIE-based global matrix M for a full-wave propagation analysis of a body Ω_{C} immersed in an electromagnetic field emitted by at least one source of energy Ω_{S}. In this exemplary case, the method may involve computing a product of VU basis functions with a (e.g., Helmoltz) kernel known per se.

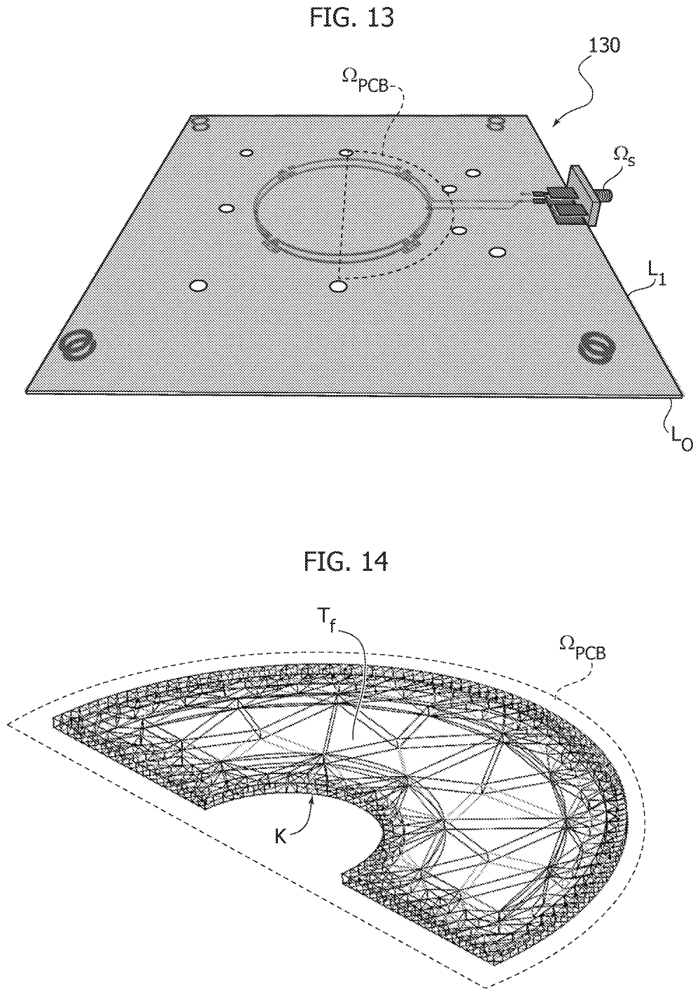

FIG. 13 shows a perspective view of a PCB device 130 suitable to be designed (and manufactured) or analyzed with the method as per the present disclosure.

As exemplified in FIG. 13, the PCB can comprise a plurality of layers L0, L1 (from bottom to top) forming a sandwich structure of conductive and insulating materials, in a manner known per se.

For instance, various components can be present on different layers L0, L1 e.g., a transmitter antenna, and the source of electromagnetic energy Ωs (for instance, a high-frequency generator or a voltage regulator). The layers L0, L1 and electrical elements therein can be coupled with electrical vias, which are copper-plated holes that function as electrical tunnels (or vias) through the insulating substrate, in a manner known per se.

As exemplified in FIG. 13, top layer L1 can be dedicated to providing power supply to the antenna with and bottom layer being at ground level.

A PCB populated with electronic components is called a printed circuit assembly (PCA), printed circuit board assembly or PCB assembly (PCBA). As discussed herein, the term “printed circuit board” is used to refer to both “printed circuit board” and “printed circuit assembly” (that is, with electrical components mounted thereon).

As exemplified in FIG. 14, at least a portion Ω_{PCB} (e.g., a half-circuit, thanks to mirror symmetry properties, in a manner known per se) of the PCB 130 may be analyzed and/or designed (and/or, manufactured) with the method as per the present disclosure, taking into account eddy currents and/or other electromagnetic phenomena.

For instance, the analyzing the PCB with the method comprises:
generating the meshed structure K exemplified in FIG. 14,
(numerically) determining a physical parameter, in particular an electrical current density J flowing into the PCB 130, by using an embodiment of the method for computing values of physical parameters of a conductive body immersed in an electromagnetic field produced by at least one source of electromagnetic energy j_{S} here described,
displaying a graphic visualization of the physical parameter, in particular determined spatiotemporal current density j in the conductive body Ω_{C}, as a map representation in space, e.g. a 2D space or 3D space corresponding to a 2D or 3D meshed structure K where to the bi-dimensional or three-dimensional coordinate on the meshed structure K is associated a graphic representation of the value of the physical parameter, e.g. spatiotemporal current density j, for instance assigning a pixel depth (e.g., grayscale or color scale) to numerically determined current density values J superimposed to the mesh K.

In one aspect, the method comprises analyzing the displayed graphic visualization and localizing therein (e.g., at a glance) areas where electrical currents induced J may present a higher density, for instance as those areas having a darker gray or black coloring.

In another aspect, the method comprises analyzing the displayed graphic visualization and localizing (e.g., at a glance) areas where values of induced electrical current J are above or below a certain threshold, where the threshold can be graphically associated to a certain color in the color scale or gray level in the grayscale, for instance.

In a further aspect, special graphic elements such as arrows, segments or icons, for instance, are displayed to graphically represent properties of the computed current density values J, e.g., their direction in space with respect to a Cartesian reference system.

In one or more embodiments, the method comprises adjusting the physical parameters of the circuit based on the analysis of the displayed graphic visualization of the determined electrical current density values J.

For instance, making assumptions with respect to resistivity, circuit parameters such as diameter of the PCB circuit 130, the conductivity or thickness of the wires may be adjusted based on analysis of electrical current densities J computed with the method as per the present disclosure. Such adjustment can be manual, e.g., by trial and error, changing one or more circuit parameters of the conductive body Ω_{S}, Ω_{PCB} and then re-running the method for computing values of physical parameters of a conductive body Ω_{S}, Ω_{PCB} here described generating a further graphic representation to be analyzed. For instance, iterative cycles of adjustment and method re-run can be performed.

In variant embodiments, automatic adjustments of one or more of said circuit parameters may be performed, based on the physical parameters determined by the method, in particular the determined electrical current density values J, and on design rules or laws, e.g., simulating an increasing the cross-section of a given conductor of the body Ω_{S}, Ω_{PCB} of a given amount or percentage if the electrical current density is above a certain threshold. In particular, the method may finally comprise manufacturing the conductor body with one or more (e.g., cross-section) values determined via the operation of adjusting parameter values.

In another aspect, the method of numerically simulating electrical current densities J discussed herein facilitates obtaining an estimate of power dissipated into the PCB 130, in particular due to induced electrical currents.

For instance, the method comprises:
based on a (per se known) relation between impedance and dissipated power, producing an equivalent circuit model of the analyzed PCB 130, and
adjusting the values of elements (e.g., capacitances, inductance) of the equivalent circuit (e.g., exploiting commercially available methods) of the analyzed PCB 130.

In particular, the method may further comprise also manufacturing the (PCB) conductive body Ω_{PCB}, Ω_{S} using the values of elements of the equivalent circuit as determined by the operation of adjusting their values.

As discussed in the foregoing, the method as per the present disclosure facilitates performing computations on a mesh K having hexahedral mesh elements T_{f}, which facilitate modeling the sandwiched layers of the device Ω_{PCB} as faces of polyhedra T_{f} are parallel to the surface of the PCB layers L0, L1.

As exemplified in FIG. 14, the method as disclosed herein can be used on meshes K including mesh elements of heterogeneous shape and size. For instance, the mesh K comprises a mix of polygons and polyhedrons, e.g., triangles or quadrangular polygons and tetrahedra or hexahedra.

As exemplified herein, a computer-implemented or computerized method comprises computing physical parameters (for instance, J, U, Z) of a conductive body (for instance, Ω_{C}; Ω_{PCB}) immersed in an electromagnetic field produced by at least one source of electromagnetic energy (for instance, j_{S}).

As exemplified herein, the method comprises:
obtaining (for instance, 200, 220) geometrical shapes and volumes in space of the conductive body, respectively,
generating (for instance, 202, 204) a mesh structure (for instance, K) comprising a plurality of V mesh elements (for instance, T, T_{fA}, T_{B}) configured to partition the obtained geometrical shape and volume of the conductive body, wherein each mesh element (for instance, T_{f}, T′_{f}) in the plurality of V mesh elements has a set of vertexes (for instance, nₐ, n_{b}, n_{c}, n_{d}) connected therebetween via a set of edges (for instance, e₁, e₂, e₃), edges in the set of edges connected therebetween via a set of F faces (for instance, f₁, f₂, f₃) having respective barycenters (bⱼ) therein, the set of edges having respective dual edges (for instance, \tilde{e}_{f1}, \tilde{e}_{f2}),
applying a Galerkin method to an electrical field integral equation, EFIE, of the conductive body, obtaining a discrete linear system of equations as a result, the discrete linear system of equations comprising an inductance mass matrix M (e.g., together with a resistivity mass matrix, R), the mass inductance matrix being a square matrix of size equal to the size of the set of F faces,
computing (for instance, 240) an array of volume uniform, VU, basis functions (for instance, Wfj) configured to locally approximate the physical parameters of the conductive body in a respective volume of each mesh element of the generated mesh structure and arranging the computed array of VU basis functions as a set of sparse basis function matrices (for instance, Ex, Ey, Ez),
computing (for instance, 243, 245, 247, 248) at least one sparse component (for instance, N_{S}) of a first matrix (for instance, N_{S}, N*), the first matrix (for instance, N) stemming from a factorized expression (e.g., obtained via factoring) of the mass inductance matrix M, the factorized expression of the mass inductance matrix M comprising a product of the first matrix and sparse basis function matrices in the set of sparse basis function matrices, the first matrix having a size equal to a size of the plurality of V mesh elements in the mesh structure, the size of the plurality of V mesh elements being lower than the number of faces F of mesh elements in the mesh structure,
computing a solution vector (for instance, 2430, 2450, 2470, 248) of the discrete linear system of equations based on a product of the at least one sparse component computed of the first matrix and at least one of the basis function matrices, obtaining physical parameters of the conductive body as a result, and
providing the obtained physical parameters (J, U, Z) of the conductive body (Ω_{C}; Ω_{PCB}) to a user circuit (12).

As exemplified herein, the method comprises computing (for instance, 240) volume uniform, VU, basis functions in the array of VU basis function as a function of respective barycenters (for instance, bⱼ) of the F faces in the set of F faces (for instance, f₁, f₂, f₃) faces and the set of dual edges of each mesh element in the mesh structure, wherein the VU basis functions are invariant in every point inside the volume of the respective mesh element in the mesh structure.

As exemplified herein, the factorized expression of the mass inductance matrix M based on a product of the first matrix and the set of sparse basis function matrices is expressed as M= [symbol] ( [symbol] + [symbol] + [symbol] ) [symbol] _{F}_{_{B}}+S where [symbol] _{B} is a sparse global restriction matrix having a unitary term per item, [symbol] is the reduced matrix, and [symbol] ₓ, [symbol] _{y} and [symbol] _{z} are the set of sparse basis function matrices including the array of VU basis functions (W), S is a global stabilization matrix.

As exemplified herein, the stabilization matrix S is a sparse stabilization matrix including a diagonal component of non-zero values.

As exemplified herein, the method comprises computing the solution vector of the discrete linear system of equations by using an iterative method, preferably generalized minimal residual method, GMRES.

As exemplified herein, computing the solution vector of the discrete linear system of equations comprises computing a seed vector (for instance, I_{N}) using, alternatively: i) analytic compression processing (for instance, 245), preferably comprising fast multipole method, FMM, processing, and ii) algebraic compression processing (for instance, 247), preferably comprising adaptive cross approximation, ACA, and iteratively computing (248) a solution by computing a solution vector (for instance, I) by populating the seed vector (for instance, I_{N}) and checking whether it satisfies the discrete linear system of equations.

As exemplified herein, computing the sparse component of the first matrix comprises computing a set of double-integral values n^{hk} expressed as:

$${n}^{hk} = \frac{{μ}_{0}}{4 π} {\int }_{{v}_{h}} {\int }_{{v}_{k}} \frac{1}{\vert r - {r}^{′} \vert} {dv}_{h} {dv}_{k}$$

where h, k are indexes having values in the range 1 to V, vₖ is a volume of a k-th mesh element, r is a distance from the source, and r′ is a distance between the k-th mesh element and a h-th mesh element different from the k-th mesh element.

As exemplified herein, the method further comprises using singularity extraction, SE and computing the set of double-integral values t^{hk} where r′ is a distance of a h-th mesh element with respect to k-th mesh elements equal to the h-th mesh element.

As exemplified herein, computing the set of double integral expressions t^{hk} comprises performing numeric integration with an integer integration order higher than first order.

As exemplified herein, at least one mesh element (for instance, T′_{f}) in the plurality of mesh elements is a hexahedron having a set of eight vertexes connected therebetween via a set of twelve edges, the edges connected therebetween via a set of six faces.

As exemplified herein, the conductive body comprises a printed-circuit-board, PCB (for instance, 130).

A processing system (for instance, 10) as exemplified herein comprises a processing device (for instance, 11) coupled to data storage device (for instance, 14), the data processing system configured to compute physical parameters (for instance, J, U, Z) of a conductive body (for instance, Ω_{C}; Ω_{PCB}) immersed in an electromagnetic field produced by at least one source of electromagnetic energy (for instance, j_{S}).

As exemplified herein, the processing system comprises at least one of an input interface (for instance, 12, 13) configured to obtain (for instance, 200, 220) a geometrical shape and volume in space of the body and of the source, respectively, and an output interface (for instance, 12) configured to a graphic visualization of the physical parameters of the body as a map representation in space of the computed values of the physical parameters of the body.

A printed circuit board, PCB, device (for instance, 130) has exemplified herein comprises at least one electric circuit ((PCB) printed thereon, the PCB device having physical parameters (for instance, J, U, Z) computed (in particular, designed and/or manufactured) using the method as per the present disclosure.

It will be otherwise understood that the various individual implementing options exemplified throughout the figures accompanying this description are not necessarily intended to be adopted in the same combinations exemplified in the figures. One or more embodiments may thus adopt these (otherwise non-mandatory) options individually and/or in different combinations with respect to the combination exemplified in the accompanying figures.

Without prejudice to the underlying principles, the details and embodiments may vary, even significantly, with respect to what has been described by way of example only, without departing from the extent of protection. The extent of protection is defined by the annexed claims.

1. A computerized method, comprising computing values of physical parameters (J, U, Z) of a conductive body (Ω_{C}; Ω_{PCB}) immersed in an electromagnetic field produced by at least one source of electromagnetic energy (j_{S}), the method comprising:
providing geometrical shape and volume in space of the conductive body (Ω_{C}; (Ω_{PCB}),
generating a mesh structure (K) comprising a plurality of mesh elements (T, T_{fA}, T_{fB}) configured to partition the geometrical shape and volume of the conductive body (Ω_{C}; (Ω_{PCB}), wherein each mesh element (T_{f}, T′_{f}) in the plurality of mesh elements (T, T_{fA}, T_{fB}) has a set of vertexes (nₐ, n_{b}, nc,n_{d}) connected therebetween via a set of edges (e₁, e₂, e₃), wherein edges in the set of edges (e₁, e₂, e₃) are coupled therebetween via a set of faces (f₁, f₂, f₃) having respective barycenters (bⱼ) therein, the set of edges having respective dual edges (\tilde{e}_{f1}, \tilde{e}_{f2}),
applying a Galerkin method to an electrical field integral equation, EFIE, of the conductive body (Ω_{C}; Ω_{PCB}) immersed in the electromagnetic field produced by the at least one source of electromagnetic energy (j_{S}), obtaining a discrete linear system of equations as a result, the discrete linear system of equations comprising an inductance mass matrix (M), the mass inductance matrix (M) being a square matrix of size equal to the size of the set of F faces,
computing an array of volume uniform, VU, basis functions (Wfⱼ) configured to locally approximate the physical parameters of the conductive body (Ω_{C}; Ω_{PCB}) in a respective mesh element (Tf) of the generated mesh structure (K) and arranging the computed array of VU basis functions (Wfⱼ) as a set of sparse basis function matrices (Ex, Ey, Ez),
computing at least one sparse component (N_{S}N*) of a first matrix (N), the first matrix (N) stemming from a factorized expression of the mass inductance matrix M, the factorized expression of the mass inductance matrix M comprising a product of the first matrix (N) and sparse basis function matrices in the set of sparse basis function matrices (Eₓ, E_{y}, E_{z}), the first matrix (N) having a size equal to a size of the plurality of mesh elements (T, T_{fA}, T_{fB}) in the mesh structure (K), the size of the plurality of mesh elements (T, T_{fA}, T_{fB}) being lower than the number of faces of mesh elements (Tf, T′f) in the mesh structure (K),
computing a solution vector (I) of the discrete linear system of equations based on a product of the at least one sparse component (N_{S}) of the first matrix (N) and at least one of the basis function matrices (Eₓ, E_{y}, E_{z}), computing physical parameters (J, U, Z) of the conductive body (Ω_{C}; Ω_{PCB}) as a result, and
providing the computed values of the physical parameters (J, U, Z) of the conductive body (Ω_{C}; Ω_{PCB}) to a user circuit.

2. The method of claim 1, comprising computing volume uniform, VU, basis functions in the array of VU basis functions (Wfⱼ) as a function of respective barycenters (bⱼ) of the faces in the set of faces (f₁, f₂, f₃) and the set of dual edges of each mesh element (T, T_{fA}, T_{fB}) in the mesh structure (K), wherein VU basis functions in the array of VU basis functions (Wfj) are invariant inside the volume of the respective mesh elements (T, T_{fA}, T_{fB}) in the mesh structure (K).

3. The method of claim 1, wherein the factorized expression of the mass inductance matrix M comprising the product of the first matrix (N) and the set of sparse basis function matrices (Eₓ, E_{y}, E_{z}) is
$$M = {𝕆}_{{F}_{B}}^{T} ( {\tilde{𝔼}}_{x}^{T} N {\tilde{𝔼}}_{x} + {\tilde{𝔼}}_{y}^{T} ℕ {\tilde{𝔼}}_{y} + {\tilde{𝔼}}_{z}^{T} N {\tilde{𝔼}}_{z} ) {𝕆}_{{F}_{B}} + S$$
where [symbol]
_{B} is a sparse global restriction matrix having a unitary term per item, [symbol]
is the first matrix, [symbol]
ₓ, [symbol] _{y} and [symbol] _{z} are the set of sparse basis function matrices including the array of VU basis functions (Wfⱼ), and
S is a global stabilization matrix.

4. The method of claim 3, wherein the global stabilization matrix S is a sparse stabilization matrix including a diagonal component of non-zero values.

5. The method of claim 1, wherein computing the solution vector (I) of the discrete linear system of equations comprises using an iterative method, preferably generalized minimal residual method, GMRES.

6. The method of claim 1, wherein computing the solution vector (I) of the discrete linear system of equations comprises:
computing a seed vector (I_{N}) using, alternatively:
analytic compression processing, preferably comprising fast multipole method, FMM, processing, and
algebraic compression processing, preferably comprising adaptive cross approximation, ACA, and
iteratively computing the solution vector (I) by populating a seed vector (I_{N}) and checking whether the populated seed vector (I_{N}) satisfies the discrete linear system of equations.

7. The method of claim 1, wherein computing the at least one sparse component (Nₛ) of the first matrix (N), comprises computing a set of double-integral values t^{hk} expressed as:
$${t}^{hk} = \frac{{μ}_{0}}{4 π} {\int }_{{v}_{h}} {\int }_{{v}_{k}} \frac{1}{\vert r - {r}^{′} \vert} {dv}_{h} {dv}_{k}$$
where
h, k are indexes having values in the range 1 to V,
vₖ is a volume of a k-th mesh element ( ),
r is a distance from the source, and
r′ is a distance of a h-th mesh element with respect to k-th mesh elements different from the h-th mesh element.

8. The method of claim 7, further comprises computing the set of double-integral values t^{hk} where r′ is a distance of a h-th mesh element with respect to k-th mesh elements equal to the h-th mesh element using singularity extraction, SE.

9. The method of claim 7, wherein computing the set of double integral expressions t^{hk} comprises performing numeric integration with an integer integration order higher than first order.

10. The method of claim 1, wherein at least one mesh element (T′_{f}) in the plurality of mesh elements (T, T_{fA}, T_{fB}) comprises a hexahedron or a quadrangular polygon.

11. The method of claim 1, wherein:
the method is implemented on a processing system comprising a data storage device, and
the method comprises storing into the data storage device the computed at least one sparse component (N_{S}, N*) of the first matrix (N).

12. A processing system comprising a processing device coupled to a data storage device, the data processing system configured to compute values of physical parameters (J, U, Z) of a conductive body (Ω_{C}; (Ω_{PCB}) immersed in an electromagnetic field produced by at least one source of electromagnetic energy (j_{S}) according to the method of claim 1.

13. The processing system of claim 12, comprising at least one of:
an input interface configured to receive geometrical shapes and volumes in space of the conductive body (Ω_{C}; Ω_{PCB}) and of the source (j_{S}), respectively,
an output interface configured to display a graphic visualization of the physical parameters (J, U, Z) of the conductive body (Ω_{C}; Ω_{PCB}) as a map representation in space of the computed values of the physical parameters (J, U, Z) of the conductive body (Ω_{C}; Ω_{PCB}).

14. A computer program product comprising instructions which, when the program is executed by the processing system, cause the processing system to compute values of physical parameters (J, U, Z) of a conductive body (Ω_{C}) immersed in an electromagnetic field produced by at least one source of electromagnetic energy (j_{S}) according to the method of claim 1.

15. A printed circuit board, PCB, device having at least one electric circuit (Ω_{PCB}) printed thereon, the PCB device having values of physical parameters (J, U, Z) determined using the method of claim 1.
